(19) United States
(12) Patent Application Publication
(10) Pub. No.: US 2021/0132906 A1
(43) Pub. Date: May 6, 2021

(54) CONSTRUCTION METHOD of MSD PARALLEL ADDER BASED ON TERNARY LOGIC OPERATOR

(71) Applicant: SHANGHAI UNIVERSITY, Shanghai (CN)

(72) Inventors: Yi JIN, SHANGHAI (CN); Yunfu SHEN, SHANGHAI (CN); Shan OUYANG, SHANGHAI (CN); Junjie PENG, SHANGHAI (CN); Junjie ZHANG, SHANGHAI (CN); Hongjian WANG, SHANGHAI (CN)

(21) Appl. No.: 17/120,077

(22) Filed: Dec. 11, 2020

Related U.S. Application Data
(63) Continuation of application No. PCT/CN2020/079172, filed on Feb. 13, 2020.

(30) Foreign Application Priority Data
Nov. 4, 2019 (CN) 201911066871.2

(51) Int. Cl. G06F 7/505; G06E 1/04

(52) U.S. Cl. CPC G06F 7/505; G06E 1/04

(57) ABSTRACT

Disclosed is a method for configuring an MSD parallel adder based on ternary logic operators. Five ternary logic operators that satisfy a sufficient condition for MSD addition are used to configure an MSD parallel adder. During the arrangement of a ternary logic operator, any method in the following may be used: each of ternary operators of n bits is reconfigured into a ternary logic operator each time, and reconfiguration is performed five times for implementation; each of ternary operators of n bits is reconfigured into two ternary logic operators having the same input each time, and reconfiguration is performed three times for implementation; each of ternary operators of n bits is reconfigured into five ternary logic operators of the same time, and reconfiguration is performed once for implementation; corresponding unreconfigurable ternary logic operators are used instead for the foregoing reconfiguration process.

### CROSS-REFERENCE TO RELATED APPLICATIONS

This application is a continuation of International Patent Application No. PCT/CN2020/079172 with a filing date of Feb. 13, 2020, designating the United States, now pending, and further claims priority to Chinese Patent Application No. 201911066871.2 with a filing date of Nov. 4, 2019. The content of the aforementioned applications, including any intervening amendments thereto, are incorporated herein by reference.

### TECHNICAL FIELD

This invention relates to the technical field of computer science and technology, and specifically, to a modified signed-digit (MSD) parallel adder (a binary parallel adder using MSD number for expression, an MSD parallel adder for short) based on ternary logic operators and the construction method of the adder.

### BACKGROUND

At present, an adder in an electronic computer is restricted by a consecutive carry process. An adder with a relatively large quantity of bits needs to withstand a delay caused by a carry process. A parallel adder is implemented relying on a carry lookahead structure only when there are a few bits. The complexity of the carry lookahead structure increases rapidly as a quantity of bits increases. As a result, it is difficult to implement a parallel carry lookahead adder with more than five bits, leading to the loss of the practicality of engineering.

A feature of MSD number addition is that a carry to a next higher bit does not cause another carry from the next higher bit to an even higher bit. Therefore, MSD addition does not involve consecutive carries. This feature determines that an MSD adder does not have a delay problem caused by consecutive carries. The MSD adder independently completes carries from data bits to next higher bits at the same time and performs an addition operation of two pieces of input data at a current bit and a carry value from a next lower bit. Therefore, the MSD adder is an adder that performs parallel work and is not related to the quantity of bits.

An MSD number is specifically a binary counting scheme that uses three symbols, namely, 1, 0, and 1̅, to express a numerical value. Doctor Algirdas Avizienis proposed this counting scheme in 1959, which provides a group of special binary addition units to implement a parallel addition operation of this counting scheme. However, the scheme has the following problem: Internal logic relationships between the provided binary addition units have not been disclosed. As a result, the provided method is only an isolated specific example and lacks integrity in the scientific aspect, and the adder structure cannot be optimized. This invention adequately resolves this problem. In 1986, Barry L. Drake, et al. formulated the function of this group of binary addition units designed by Algirdas Avizienis into a group of symbol replacement rules. However, the scheme has the following problem: The provided symbol replacement rules are completely variations of operation rules of the specific example of the adders provided by Algirdas Avizienis. An internal relationship between an MSD parallel adder and a ternary logic operator is still not disclosed. As a result, the structure of the adders cannot be optimized. This invention fully resolves this problem. In 2010, Dr. JIN Yi took this group of symbol replacement rules as a group of ternary logic operation rules. Therefore, an MSD parallel optical adder is implemented on a reconfigurable ternary optical operator. However, the scheme has the following problem: Internal relationships are only established between the symbol replacement rules provided by Barry L. Drake, et al. and corresponding ternary logic operators, so that a relationship is also established between the specific example of the adder provided by Algirdas Avizienis and a corresponding ternary logic operator, but a complete relationship between MSD addition operation and ternary logic operation is not established. The adder structure in this solution cannot be optimized. This invention resolves this problem. In October 2010, Dr. PENG Junjie, et al. made improvements to the MSD parallel optical adder proposed by JIN Yi, and applied for a Chinese Invention Patent (ZL201010518342.4). In the patent, three liquid-crystal ternary optical operators stacked together are used to implement the structure of an optical MSD parallel adder provided by Dr. JIN Yi. An MSD parallel adder formed by stacking three liquid-crystal ternary optical operators is provided. The ternary logic operators formed by three liquid-crystal ternary optical operators are all ternary logic-optical operators. However, the patent has the following problem: A new optical device configuration solution is only provided for the optical adder structure provided by JIN Yi, where the ternary logic operator used for the adder cannot be replaced, and therefore the adder structure cannot be simplified or optimized. This invention fully resolves this problem.

At present, no description or report of a technology similar to that of this invention has been found, and no similar data has been collected worldwide.

### SUMMARY

In view of the foregoing deficiencies in the prior art, an internal relationship between an MSD parallel adder and a ternary logic operator is fully disclosed in this invention. Therefore, an MSD parallel adder and its construction method based on ternary logic operators are provided. A general method is proposed for configuring an MSD parallel adder by using ternary logic operators, and it has advantages such as varied adder structures, standard configuration methods, easily optimizable adder structures, and complete configuration theory.

To achieve the foregoing objective, the following technical solutions are adopted in this invention.

According to an aspect of this invention, a method for configuring an MSD parallel adder based on ternary logic operators is provided, where five ternary logic operators that satisfy a sufficient condition for MSD addition are used to configure an MSD parallel adder, and the sufficient condition for MSD addition is:

if for any two MSD numbers, namely, a=aₙ₋₁ . . . a₁a₀ and b=bₙ₋₁ . . . b₁b₀, five different ternary logic operation rules Y, F, Y′, F′, and S are used to successively perform bit conversion, and the following four conditions are satisfied, then, an obtained number s=sₙ₊₁sₙ . . . s₁s₀ is a sum value of a and b, and s is an MSD number;

Condition 1: aᵢ+bᵢ=yᵢ₊₁×2+fᵢ, where i=0, 1, . . . , n−1; and y₀=fₙ=ϕ, where ϕ represents an added 0 (the same below);

Condition 2: yᵢ+fᵢ=y′ᵢ₊₁×2+f′ᵢ, where i=0, 1, . . . , n; and y′₀=f′ₙ₊₁=ϕ;

Condition 3: y′ᵢ+f′ᵢ=sᵢ, where i=0, 1, . . . , n+1; and

Condition 4: y′ᵢ and f′ᵢ are not 1 at the same time and are not 1̅ at the same time, where i=0, 1, . . . , n+1; and

yᵢ, fᵢ, y′ᵢ, f′ᵢ, and sᵢ in the foregoing four conditions are respectively obtained from the following operations:

for aᵢ and bᵢ, Y conversion is performed to obtain yᵢ₊₁, and F conversion is performed to obtain fᵢ, where y=yₙyₙ₋₁ . . . y₂y₁ϕ, and f=ϕfₙ₋₁ . . . f₁f₀;

for yᵢ and fᵢ, Y′ conversion is performed to obtain y′ᵢ₊₁, and F′ conversion is performed to obtain f′ᵢ, where y′=y′ₙ₊₁y′ₙ . . . y′₃y′₂y′₁ϕ, and f′=ϕf′ₙf′ₙ₋₁ . . . f′₁f′₀; and

for y′ᵢ and f′ᵢ, S conversion is performed to obtain sᵢ, where s=sₙ₊₁sₙ . . . s₁s₀.

Preferably, each ternary logic operation rule corresponds to one ternary logic operator, and within the constraint of the four conditions, there are a total of seven groups of five ternary logic operators that can form an MSD parallel adder as follows:

| Type | Y operator | | | | F operator | | | | Y′ operator | | | | F′ operator | | | | S operator | | | |
|---|---|---|---|---|---|---|---|---|---|---|---|---|---|---|---|---|---|---|---|---|
| | aᵢ | 0 | l̅ | 1 | aᵢ | 0 | l̅ | 1 | fᵢ | 0 | l̅ | 1 | fᵢ | 0 | l̅ | 1 | f′ᵢ | 0 | l̅ | 1 |
| | bᵢ | | | | bᵢ | | | | yᵢ | | | | yᵢ | | | | y′ᵢ | | | |
| 1 | 0 | 0 | l̅ | 1 | 0 | 0 | 1 | l̅ | 0 | 0 | v | t | 0 | 0 | x | w | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 2 | 0 | 0 | 0 | 1 | 0 | 0 | l̅ | l̅ | 0 | 0 | l̅ | 0 | 0 | 0 | 1 | 1 | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 3 | 0 | 0 | l̅ | 0 | 0 | 0 | 1 | 1 | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 4 | 0 | 0 | l̅ | 1 | 0 | 0 | 1 | l̅ | 0 | 0 | l̅ | 0 | 0 | 0 | 1 | 1 | 0 | 0 | l̅ | 1 |
| | l̅ | 0 | l̅ | 0 | l̅ | l̅ | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 5 | 0 | 0 | l̅ | 1 | 0 | 0 | 1 | l̅ | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 0 | 0 | 1 | 1 | 1 | 0 | 0 | 1 | 0 | 0 | 1 | 1 | 1 | 0 | 0 | 1 | 1 | 0 | * |
| 6 | 0 | 0 | l̅ | 0 | 0 | 0 | 1 | 1 | 0 | 0 | | 1 | 0 | 0 | | l̅ | 0 | 0 | l̅ | 1 |
| | l̅ | l̅ | l̅ | 0 | l̅ | 1 | 0 | 0 | l̅ | 0 | | 0 | l̅ | l̅ | | 0 | | | | |
| | 1 | 0 | 0 | 1 | 1 | 1 | 0 | 0 | 1 | t | | 1 | 1 | w | | 0 | 1 | 1 | 0 | * |
| 7 | 0 | 0 | 0 | 1 | 0 | 0 | l̅ | l̅ | 0 | 0 | 1 | | 0 | 0 | l̅ | | 0 | 0 | l̅ | |
| | l̅ | 0 | l̅ | 0 | l̅ | l̅ | 0 | 0 | l̅ | X | 0 | | l̅ | v | l̅ | | l̅ | l̅ | * | |
| | 1 | 1 | 0 | 1 | 1 | l̅ | 0 | 0 | 1 | 1 | 0 | | 1 | 0 | 0 | | 1 | 1 | 0 | |

Note:
* may be 0, l̅ or 1;
(x, v) is (1, l̅) or (l̅, 0); and
(t, w) is (1, l̅) or (0, 1).

Preferably, a method for configuring an MSD parallel adder by using five ternary logic operators that satisfy the sufficient condition for MSD addition includes:

S1. selecting a group of ternary logic operation rules that satisfy the sufficient condition for MSD addition;

S2. configuring, according to the group of ternary logic operation rules selected in S1, a ternary logic operator sequence that satisfies the sufficient condition for MSD addition, including:

\textcircled{1} arranging an operation order for a group of ternary logic operators having a fixed function, and configuring a ternary logic operator sequence that satisfies the sufficient condition for MSD addition;

\textcircled{2} arranging an operation order for a group of ternary logic operators formed by performing a reconfiguration operation on ternary operators having an operation configuration function, and configuring a ternary logic operator sequence that satisfies the sufficient condition for MSD addition; and

S3. configuring MSD parallel adders with different physical properties according to the structure of the ternary logic operators that satisfy the sufficient condition for MSD addition determined in S2 and by using ternary operators with different physical properties.

Preferably, in S2, a method for configuring, by using ternary operators, the ternary logic operator that satisfies the sufficient condition for MSD addition is any of the following:

\textcircled{1} sequentially configuring, by reconfiguring the ternary operators five times by using reconfigurable ternary operators, the ternary operators into five ternary logic operators that satisfy the sufficient condition for MSD addition;

\textcircled{2} arranging, by reconfiguring the ternary operators three times by using reconfigurable ternary operators, the ternary operators into five ternary logic operators that satisfy the sufficient condition for MSD addition, where during the first two times of reconfiguration, two halves of the ternary operators are respectively configured into two ternary logic operators with the same input data in the five ternary logic operators that satisfy the sufficient condition for MSD addition;

\textcircled{3} arranging, by reconfiguring the ternary operators once by using reconfigurable ternary operators, the ternary operators into five ternary logic operators that satisfy the sufficient condition for MSD addition, where during the reconfiguration, the ternary operators are divided into five parts, and each part is configured into one of the five ternary logic operators that satisfy the sufficient condition for MSD addition;

\textcircled{4} configuring m+2 data bits of adder by using reconfigurable ternary operators to implement a parallel adder with m-bit input data, where m represents an assumed quantity of data bits for configuring an MSD parallel adder, each data bit of adder includes five ternary operator bits, and each ternary operator bit is configured into one of the five ternary logic operators that satisfy the sufficient condition for MSD addition.

Preferably, a method for configuring an MSD parallel adder by reconfiguring the ternary operators five times includes:

Assuming that a ternary operator has n operator bits;

during the first time of reconfiguration, configuring n−2 operator bits of a ternary operator into an (n−2)-bit Y operator, where all original data is grouped according to n−2 bits, each group of data is converted by using a Y operator, and one 0 is added to the tail of a conversion result each time, to obtain various groups of data of first-type intermediate results y;

during the second time of reconfiguration, configuring n−2 operator bits of a ternary operator into an (n−2)-bit F operator, where all original data is grouped according to n−2 bits, each group of data is converted by using an F operator, and one 0 is added to the head of a conversion result each time, to obtain various groups of data of first-type intermediate results f;

during the third time of reconfiguration, configuring n−1 operator bits of a ternary operator into an (n−1)-bit Y′ operator, where all first-type intermediate results are grouped according to n−1 bits, each group of data is converted by using a Y′ operator, and one 0 is added to the tail of a conversion result each time, to obtain various groups of data of second-type intermediate results y′;

during the fourth time of reconfiguration, configuring n−1 operator bits of a ternary operator into an (n−1)-bit F′ operator, where all first-type intermediate results are grouped according to n−1 bits, each group of data is converted by using an F′ operator, and one 0 is added to the head of a conversion result each time, to obtain various groups of data of second-type intermediate results f′; and

during the fifth time of reconfiguration, configuring n operator bits of a ternary operator into an n-bit S operator, where all second-type intermediate results are grouped according to n bits, and each group of data is converted by using an S operator, to obtain an adder operational result s.

Preferably, a method for configuring an MSD parallel adder by reconfiguring the ternary operators three times includes:

Assuming that a ternary operator has n operator bits, where the 0^{th} bit to an ((n/2)−1)^{th} bit are referred to as a low-bit order part, and an (n/2)^{th} bit to an (n−1)^{th} bit are referred to as a high-bit order part;

during the first time of reconfiguration, configuring n/2−2 operator bits in the low-bit order part of the ternary operator into an (n/2−2)-bit Y operator, and configuring n/2−2 operator bits in the high-bit order part into an (n/2−2)-bit F operator, where all original data is grouped according to n/2−2 bits, each group of data is converted by using both a Y operator and an F operator, and for each time of conversion, and one 0 is added to the tail of each output value of the Y operator and one 0 is added to the head of each output value of the F operator, to respectively obtain various groups of data of first-type intermediate results y and various groups of data of first-type intermediate results f;

during the second time of reconfiguration, configuring n/2−1 operator bits in the low-bit order part of the ternary operator into an (n/2−1)-bit Y′ operator, and configuring n/2−1 operator bits in the high-bit order part into an (n/2−1)-bit F′ operator, where the first-type intermediate results are grouped according to n/2−1 bits, each group of data is converted by using both a Y′ operator and an F′ operator, and one 0 is added to the tail of each output value of the Y′ operator and one 0 is added to the head of each output value of the F′ operator, to respectively obtain various groups of data of second-type intermediate results y′ and various groups of data of second-type intermediate results f′; and

during the third time of reconfiguration, configuring n/2 operator bits in the low-bit order part or the high-bit order part of the ternary operator into an n/2-bit S operator, where all the second-type intermediate results are grouped according to n/2 bits, and each group of data is converted by using an S operator, to obtain an adder operational result s.

Preferably, a method for configuring an MSD parallel adder by reconfiguring the ternary operators once includes:

Assuming that a ternary operator has n operator bits, where n is greater than or equal to 5m+4, and m represents an assumed quantity of data bits for configuring an MSD parallel adder;

during the reconfiguration, configuring the 0^{th} bit to an (m−1)^{th} bit of the ternary operator into a Y operator, configuring an m^{th} bit to a (2m−1)^{th} bit of the ternary operator into an F operator, configuring a 2m^{th} bit to a 3m^{th} bit of the ternary operator into a Y′ operator, configuring a (3m+1)^{th} bit to a (4m+1)^{th} bit of the ternary operator into an F′ operator, and configuring a (4m+2)^{th} bit to a (5m+3)^{th} bit of a ternary operator into an S operator;

grouping all original data according to m bits, where each group of data is converted by using both a Y operator and an F operator, and for each time of conversion, one 0 is added to the tail of an output value of the Y operator and one 0 is added to the head of an output value of the F operator, to respectively obtain various groups of data of first-type intermediate results y and various groups of data of first-type intermediate results f;

converting all the groups of data of the first-type intermediate results by using both a Y′ operator and an F′ operator, where for each time of conversion, one 0 is added to the tail of an output value of the Y′ operator and one 0 is added to the head of an output value of the F′ operator, to respectively obtain various groups of data of second-type intermediate results y′ and various groups of data of second-type intermediate results f′; and

converting all the groups of data of the second-type intermediate results by using an S operator, to obtain an adder operational result s.

Preferably, in the MSD parallel adder configured by reconfiguring the ternary operators once, an i^{th}-bit output terminal of a Y operator and an (i+1)^{th}-bit output terminal of an F operator are respectively connected to two (i+1)^{th}-bit input terminals of a Y′ operator and two (i+1)^{th}-bit input terminals of an F′ operator; one 0-value terminal and a 0^{th}-bit output terminal of an F operator are respectively connected to two 0^{th}-bit input terminals of a Y′ operator and two 0^{th}-bit input terminals of an F′ operator; one 0-value terminal and a highest-bit output terminal of a Y operator are respectively connected to two highest-bit input terminals of a Y′ operator and two highest-bit input terminals of an F′ operator; an i^{th}-bit output terminal of a Y′ operator and an (i+1)^{th}-bit output terminal of an F′ operator are respectively connected to two (i+1)^{th}-bit input terminals of an S operator; one 0-value terminal and a 0^{th}-bit output terminal of an F′ operator are respectively connected to two 0^{th}-bit input terminals of an S operator; and one 0-value terminal and a highest-bit output terminal of a Y′ operator are respectively connected to two highest-bit input terminals of the S operator.

Preferably, m+2 data bits of adder are configured to implement an m-bit adder, each adder bit includes five ternary operator bits, the five ternary operator bits are respectively configured into one bit of five ternary logic operators, and a method for arranging ternary logic operators is implemented in each adder bit in the same manner, including:

Assuming that a ternary operator has n operator bits, where n is greater than or equal to 5(m+2);

reconfiguring any five operator bits of a ternary operator into one data bit of an MSD parallel adder, where m+2 data bits form an m-bit MSD parallel adder, and five operator bits in each data bit of adder are respectively reconfigured into a Y operator, an F operator, a Y′ operator, an F′ operator, and an S operator;

simultaneously feeding an i^{th} bit of original data a and an ith bit of original data b into a Y operator and an F operator of an i^{th} data bit of adder, where i=0, 1, 2, . . . , m−1; simultaneously feeding an output value of a Y operator of an i^{th} data bit and an output value of an F operator of an (i+1)^{th} data bit into two input terminals of a Y′ operator and two input terminals of an F′ operator of the (i+1)^{th} data bit; simultaneously feeding an output value of a Y′ operator of the i^{th} data bit and an output value of an F′ operator of the (i+1)^{th} data bit into two input terminals of an S operator of the (i+1)^{th} data bit; outputting, by an S operator of the i^{th} data bit, the value of an i^{th} bit of a calculation result; at the same time, feeding a 0 value terminal and an output value of an F operator of the 0^{th} data bit into two input terminals of a Y′ operator and two input terminals of an F′ operator of the 0^{th} data bit; and feeding a 0-value terminal and an output terminal of an F′ operator of the 0^{th} data bit into two input terminals of an S operator of the 0^{th} data bit; and

if an mth data bit and an (m+1)^{th} data bit still include a Y operator, an F operator, a Y′ operator, and an F′ operator, feeding two 0 values into two input terminals of Y operators and two input terminals of F operators of the m^{th} data bit and the (m+1)^{th} data bit; if a Y operator and an F operator are omitted at the m^{th} data bit, feeding an output value of a Y operator of an (m−1)^{th} data bit and a 0 value into two input terminals of a Y′ operator and two input terminals of an F′ operator of the mth data bit; and if a Y operator, an F operator, a Y′ operator, and an F′ operator are omitted at the (m+1)^{th} data bit, feeding an output value of a Y′ operator of the m^{th} data bit and a 0 value into two input terminals of an S operator of the (m+1)^{th} data bit.

Preferably, in an MSD parallel adder arranged by configuring m+2 data bits of adder, an output terminal of a Y operator of each data bit of adder is directly connected to one input terminal of a Y′ operator and one input terminal of an F′ operator of a next higher bit, and an output terminal of an F operator of each data bit of adder is directly connected to another input terminal of a Y′ operator and another input terminal of an F′ operator of a current bit; an output terminal of a Y′ operator of each data bit of adder is directly connected to one input terminal of an S operator of a next higher bit, and an output terminal of an F′ operator of each data bit of adder is directly connected to another input terminal of the S operator of the current bit; at the same time, a 0-value terminal and the output terminal of the F operator of the 0^{th} data bit are connected to two input terminals of a Y′ operator and two input terminals of an F′ operator of the 0^{th} data bit, and an output terminal of the F′ operator of the 0^{th} data bit and a 0-value terminal are connected to two input terminals of an S operator of the 0^{th} data bit; an output terminal of a Y operator of the third highest data bit and a 0-value terminal are connected to two input terminals of a Y′ operator and two input terminals of an F′ operator of the second highest data bit; an output terminal of a Y′ operator of the second highest data bit and a 0-value terminal are connected to two input terminals of an S operator of the highest data bit; and other ternary logic operators of the highest data bit do not have an output or do not work.

Preferably, the following two ternary logic operators are combined at one operator bit of a ternary operator for implementation:

a first type: a ternary logic operator with a truth table having two columns and three rows or having two columns and three rows after transposition; and

a second type: a ternary logic operator with a truth table having one column and three rows or having one column and three rows after transposition.

Preferably, if the addition of a 0 to the head of an intermediate result leads to that the highest bit is always 0 in subsequent conversion, the added 0 and the highest bit of the intermediate result are omitted or reserved.

According to a second aspect of this invention, an MSD parallel adder based on ternary logic operators is provided, and is configured by using any foregoing configuration method.

Compared with the existing methods, this invention has the following beneficial effects:

1. An internal relationship between MSD addition operation and ternary logic operation is fully disclosed, to lay out a technical roadmap for configuring a new MSD adder or improving the structure of an adder.

2. Various solutions for configuring an MSD parallel adder by using a reconfigurable ternary operator are provided.

3. A method for configuring an MSD parallel adder in which output values of a former group of ternary logic operators are directly fed into input terminals of a latter group of ternary logic operators is provided.

4. A method for implementing, at one ternary operator bit, two ternary logic operators with a truth table having two columns and three rows or one column and three rows, is provided.

### BRIEF DESCRIPTION OF THE DRAWINGS

Other features, objectives, and advantages of this invention will become more obvious by reading detailed description of non-limitative embodiments with reference to the following accompanying drawings:

FIG. 1 is a schematic structural diagram of implementing an MSD parallel adder by configuring a ternary operator five times provided in Embodiment 1 according to an embodiment of this invention.

FIG. 2 is a schematic structural diagram of implementing an MSD parallel adder by configuring a ternary operator three times provided in Embodiment 2 according to an embodiment of this invention.

FIG. 3 is a schematic structural diagram of implementing an MSD parallel adder by configuring a ternary operator once provided in Embodiment 3 according to an embodiment of this invention.

FIG. 4(a) is a schematic structural diagram of configuring an MSD parallel adder according to a data bit provided in Embodiment 4 according to an embodiment of this invention, and FIG. 4(b) shows a structure in which ternary logic operators of data bits of an MSD parallel adder are directly connected provided in Embodiment 4 according to an embodiment of this invention.

FIG. 5(a) is a schematic diagram of a method for reducing a quantity of occupied operator bits in an SJ-MSD parallel adder provided in Embodiment 5 according to an embodiment of this invention, and FIG. 5(b) shows a structure in which ternary logic operators of data bits of an MSD parallel adder are directly connected provided in Embodiment 5 according to an embodiment of this invention.

### DETAILED DESCRIPTION OF EMBODIMENTS

The embodiments of this invention are described below in detail. The embodiments are implemented under the premise of the technical solution of this invention and provides specific implementations and specific operation processes. It should be noted that for a person of ordinary skill in the art, several variations and improvements may further be made without departing from the concept of this invention. These variations and improvements should also be deemed as falling within the protection scope of this invention.

An embodiment of this invention provides a method for configuring an MSD parallel adder based on ternary logic operators, where five ternary logic operators that satisfy a sufficient condition for MSD addition are used to configure an MSD parallel adder, and the sufficient condition for MSD addition is:

if for any two MSD numbers, namely, a=aₙ₋₁ . . . a₁a₀ and b=bₙ₋₁ . . . b₁b₀, five different ternary logic operation rules Y, F, Y′, F′, and S are used to successively perform bit conversion, and the following four conditions are satisfied, an obtained number s=sₙ₊₁sₙ . . . s₁s₀ is a sum value of a and b, and s is an MSD number;

Condition 1: aᵢ+bᵢ=yᵢ₊₁×2+fᵢ, where i=0, 1, . . . n−1; and y₀=fₙ=ϕ, where ϕ is an added 0;

Condition 2: yᵢ+fᵢ=y′ᵢ₊₁×2+f′ᵢ, where i=0, 1, . . . n; and y′₀=f′ₙ₊₁=ϕ;

Condition 3: y′ᵢ+f′ᵢ=sᵢ, where i=0, 1, . . . , n+1; and

Condition 4: y′ᵢ and f′ᵢ are not 1 at the same time and are not 1̅ at the same time, where i=0, 1, . . . , n+1; and

yᵢ, fᵢ, y′ᵢ, f′ᵢ, and sᵢ in the foregoing four conditions are respectively obtained from the following operations:

apply Y conversion to aᵢ and bᵢ to get yᵢ₊₁, and apply F conversion to aᵢ and bᵢ to get meanwhile y=yₙyₙ₋₁ . . . y₂y₁, and f=fₙ₋₁ . . . f₁f₀;

apply Y′ conversion to yᵢ and fᵢ to get y′ᵢ₊₁, and apply F′ conversion to yᵢ and bᵢ to get f′ᵢ, meanwhile y=y′ₙ₊₁y′ₙ . . . y′₃y′₂y′₁, and f′=f′ₙf′ₙ₋₁ . . . f′₁f′₀; and

apply S conversion to y′ᵢ and f′ᵢ to get sᵢ, meanwhile s=sₙ₊₁sₙ . . . s₁s₀.

Preferably, each ternary logic operation rule corresponds to one ternary logic operator, and within the constraint of the four conditions, there are a total of seven groups of five ternary logic operators that can form an MSD parallel adder as follows:

| Type | Y operator | | | | F operator | | | | Y′ operator | | | | F′ operator | | | | S operator | | | |
|---|---|---|---|---|---|---|---|---|---|---|---|---|---|---|---|---|---|---|---|---|
| | aᵢ | 0 | l̅ | 1 | aᵢ | 0 | l̅ | 1 | fᵢ | 0 | l̅ | 1 | fᵢ | 0 | l̅ | 1 | f′ᵢ | 0 | l̅ | 1 |
| | bᵢ | | | | bᵢ | | | | yᵢ | | | | yᵢ | | | | y′ᵢ | | | |
| 1 | 0 | 0 | l̅ | 1 | 0 | 0 | 1 | l̅ | 0 | 0 | v | t | 0 | 0 | x | w | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 2 | 0 | 0 | 0 | 1 | 0 | 0 | l̅ | l̅ | 0 | 0 | l̅ | 0 | 0 | 0 | 1 | 1 | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 3 | 0 | 0 | l̅ | 0 | 0 | 0 | 1 | 1 | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 4 | 0 | 0 | l̅ | 1 | 0 | 0 | 1 | l̅ | 0 | 0 | l̅ | 0 | 0 | 0 | 1 | 1 | 0 | 0 | l̅ | 1 |
| | l̅ | 0 | l̅ | 0 | l̅ | l̅ | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 5 | 0 | 0 | l̅ | 1 | 0 | 0 | 1 | l̅ | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 0 | 0 | 1 | 1 | 1 | 0 | 0 | 1 | 0 | 0 | 1 | 1 | 1 | 0 | 0 | 1 | 1 | 0 | * |
| 6 | 0 | 0 | l̅ | 0 | 0 | 0 | 1 | 1 | 0 | 0 | | 1 | 0 | 0 | | l̅ | 0 | 0 | l̅ | 1 |
| | l̅ | l̅ | l̅ | 0 | l̅ | 1 | 0 | 0 | l̅ | 0 | | 0 | l̅ | l̅ | | 0 | | | | |
| | 1 | 0 | 0 | 1 | 1 | 1 | 0 | 0 | 1 | t | | 1 | 1 | w | | 0 | 1 | 1 | 0 | * |
| 7 | 0 | 0 | 0 | 1 | 0 | 0 | l̅ | l̅ | 0 | 0 | 1 | | 0 | 0 | l̅ | | 0 | 0 | l̅ | |
| | l̅ | 0 | l̅ | 0 | l̅ | l̅ | 0 | 0 | l̅ | X | 0 | | l̅ | v | l̅ | | l̅ | l̅ | * | |
| | 1 | 1 | 0 | 1 | 1 | l̅ | 0 | 0 | 1 | 1 | 0 | | 1 | 0 | 0 | | 1 | 1 | 0 | |

Note:
* may be 0, l̅ or 1;
(x, v) is (1, l̅) or (l̅, 0); and
(t, w) is (1, l̅), or (0, 1).

It should be noted that Y, F, Y′, F′, and S represent five different ternary logic operation rules, which may have various forms but must satisfy the foregoing four conditions. Under this constraint, the five ternary logic operation rules only have seven groups of types provided in the foregoing table.

Each logic operation rule corresponds to one logic operator. The logic operation rule and the logic operator are usually represented by using the same symbol, and are not distinguished again below. M SD addition is completed by the ternary logic operation rules Y, F, Y′, F′, and S, and correspondingly, MSD adders are formed by the five ternary logic operators Y, F, Y′, F′, and S.

Further, a method for configuring an MSD parallel adder by using five ternary logic operators that satisfy the sufficient condition for MSD addition includes:

S1. selecting a group of ternary logic operation rules that satisfy the sufficient condition for MSD addition;

S2. configuring, according to the group of ternary logic operation rules selected in S1, a ternary logic operator sequence that satisfies the sufficient condition for MSD addition, including:

\textcircled{1} arranging an operation order for a group of ternary logic operators having a fixed function, and configuring a ternary logic operator sequence that satisfies the sufficient condition for MSD addition;

\textcircled{2} arranging an operation order for a group of ternary logic operators formed by performing a reconfiguration operation on ternary operators having an operation configuration function, and configuring a ternary logic operator sequence that satisfies the sufficient condition for MSD addition; and

S3. configuring various MSD parallel adders with different physical properties according to the structure of the ternary logic operators that satisfy the sufficient condition for MSD addition determined in S2 and by using ternary operators with different physical properties.

The basic principle used in this embodiment of this invention is the sufficient condition for MSD addition, the condition being expressed as follows:

if for any two MSD numbers, namely, a=aₙ₋₁ . . . a₁a₀ and b=bₙ₋₁ . . . b₁b₀, the ternary logic operation rules Y, F, Y′, F′, and S are used to successively perform bit conversion, and the following four conditions are satisfied, a number s=sₙ₊₁sₙ . . . s₁s₀ is a sum value of a and b, and s is an MSD number.

Condition 1: aᵢ+bᵢ=yᵢ₊₁×2+fᵢ, where i=0, 1, . . . n−1; and y₀=fₙ=ϕ, where ϕ represents an added 0. (1)

Condition 2: yᵢ+fᵢ=y′ᵢ₊₁×2+f′ᵢ, where i=0, 1, . . . n; and y′₀=f′ₙ₊₁=ϕ. (2)

Condition 3: y′ᵢ+f′ᵢ=sᵢ, where i=0, 1, . . . n+1. (3)

Condition 4: y′ᵢ and f′ᵢ are not 1 at the same time and are not 1̅ at the same time, where i=0, 1, . . . n+1. (4)

yᵢ, fᵢ, y′ᵢ, f′ᵢ, and sᵢ in the foregoing conditions are respectively obtained from the following operations:

1) Apply Y conversion to aᵢ and bᵢ to get yᵢ₊₁, and apply F conversion to aᵢ and bᵢ to get fᵢ, meanwhile y=yₙyₙ₋₁ . . . y₂y₁, and f=fₙ₋₁ . . . f₁f₀;

2) Apply Y′ conversion to yᵢ and fᵢ to get y′ᵢ₊₁, and apply F′ conversion to yᵢ and bᵢ to get f′ᵢ meanwhile y′=y′ₙ₊₁y′ₙ . . . y′₃y′₂y′₁, and f′=f′ₙf′ₙ₋₁ . . . f′₁f′₀; and

3) Apply S conversion to y′ᵢ and f′ᵢ to get meanwhile s=sₙ₊₁sₙ . . . s₁s₀.

According to the sufficient condition for MSD addition, seven types of ternary logic operator combinations that may form a three-step MSD parallel adder are further found. See Table 1.

TABLE 1
Seven types of ternary logic operator combinations that may form
an MSD parallel adder

| Type | Y operator | | | | F operator | | | | Y′ operator | | | | F′ operator | | | | S operator | | | |
|---|---|---|---|---|---|---|---|---|---|---|---|---|---|---|---|---|---|---|---|---|
| | aᵢ | 0 | l̅ | 1 | aᵢ | 0 | l̅ | 1 | fᵢ | 0 | l̅ | 1 | fᵢ | 0 | l̅ | 1 | f′ᵢ | 0 | l̅ | 1 |
| | bᵢ | | | | bᵢ | | | | yᵢ | | | | yᵢ | | | | y′ᵢ | | | |
| 1 | 0 | 0 | l̅ | 1 | 0 | 0 | 1 | l̅ | 0 | 0 | v | t | 0 | 0 | x | w | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 2 | 0 | 0 | 0 | 1 | 0 | 0 | l̅ | l̅ | 0 | 0 | l̅ | 0 | 0 | 0 | 1 | 1 | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 3 | 0 | 0 | l̅ | 0 | 0 | 0 | 1 | 1 | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 4 | 0 | 0 | l̅ | 1 | 0 | 0 | 1 | l̅ | 0 | 0 | l̅ | 0 | 0 | 0 | 1 | 1 | 0 | 0 | l̅ | 1 |
| | l̅ | 0 | l̅ | 0 | l̅ | l̅ | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 5 | 0 | 0 | l̅ | 1 | 0 | 0 | 1 | l̅ | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 0 | 0 | 1 | 1 | 1 | 0 | 0 | 1 | 0 | 0 | 1 | 1 | 1 | 0 | 0 | 1 | 1 | 0 | * |
| 6 | 0 | 0 | l̅ | 0 | 0 | 0 | 1 | 1 | 0 | 0 | | 1 | 0 | 0 | | l̅ | 0 | 0 | l̅ | 1 |
| | l̅ | l̅ | l̅ | 0 | l̅ | 1 | 0 | 0 | l̅ | 0 | | 0 | l̅ | l̅ | | 0 | | | | |
| | 1 | 0 | 0 | 1 | 1 | 1 | 0 | 0 | 1 | t | | 1 | 1 | w | | 0 | 1 | 1 | 0 | * |
| 7 | 0 | 0 | 0 | 1 | 0 | 0 | l̅ | l̅ | 0 | 0 | 1 | | 0 | 0 | l̅ | | 0 | 0 | l̅ | |
| | l̅ | 0 | l̅ | 0 | l̅ | l̅ | 0 | 0 | l̅ | x | 0 | | l̅ | v | l̅ | | l̅ | l̅ | * | |
| | 1 | 1 | 0 | 1 | 1 | l̅ | 0 | 0 | 1 | 1 | 0 | | 1 | 0 | 0 | | 1 | 1 | 0 | |

Note:
* may be 0, l̅ or 1;
(x, v) is (1, l̅) or (l̅, 0); and
(t, w) is (1, l̅), or (0, 1).

The expressed operation rule does not change after transposition or symbol replacement is performed on the logic operation truth table. Therefore, the ternary logic operation truth tables formed by performing transposition or symbol replacement on the foregoing seven types of ternary logic operation truth tables all fall within the scope of this invention.

The method for configuring an MSD parallel adder based on ternary logic operators provided in this embodiment of this invention is not related to a physical state expressing information in a ternary logic operator, and is therefore not related to a physical property of a specific ternary operator. The method has the same effect for a ternary electronic operator, a ternary optical operator or a ternary operator having another physical property. The application scope of this invention should not be narrowed down because of different physical properties of operators.

The method for configuring an MSD parallel adder based on ternary logic operators provided in this embodiment of this invention is further described below in detail with reference to the accompanying drawings.

The implementation of the method in this embodiment of this invention by using the following three steps is emphatically described below:

S1. selecting a group of ternary logic operation rules that satisfy the sufficient condition for MSD addition;

S2, configuring, according to the group of ternary logic operation rules selected in S1, a ternary logic operator sequence that satisfies the sufficient condition for MSD addition, including:

\textcircled{1} arranging an operation order for a group of ternary logic operators having a fixed function, and configuring a ternary logic operator sequence that satisfies the sufficient condition for MSD addition;

\textcircled{2} arranging an operation order for a group of ternary logic operators formed by performing a reconfiguration operation on ternary operators having an operation configuration function, and configuring a ternary logic operator sequence that satisfies the sufficient condition for MSD addition; and

S3. configuring MSD parallel adders with different physical properties according to the structure of the ternary logic operators that satisfy the sufficient condition for MSD addition determined in S2 and by using ternary operators with different physical properties.

Embodiment 1: Method for implementing an MSD parallel adder by reconfiguring a ternary operators five times

(1) Five Ternary Logic Operators that Satisfy a Sufficient Condition for MSD addition are selected:

For example, the first-type ternary logic operator in Table 1 is selected, where (v, x)=(0, 1̅), (t, w)=(0, 1), and * is respectively 1̅ and 1. A truth table of the selected five ternary logic operators is Table 2. The five ternary logic operators are usually referred to as T, W, T′, W′, and T2, and corresponding adders are referred to as TW-MSD parallel adders.

TABLE 2
Ternary logic operator combinations that form a TW-MSD parallel adder

| Type | Y operator (T) | | | | F operator (W) | | | | Y′ operator (T′) | | | | F′ operator (W′) | | | | S operator (T2) | | | |
|---|---|---|---|---|---|---|---|---|---|---|---|---|---|---|---|---|---|---|---|---|
| | aᵢ | 0 | l̅ | 1 | aᵢ | 0 | l̅ | 1 | fᵢ | 0 | l̅ | 1 | fᵢ | 0 | l̅ | 1 | f′ᵢ | 0 | l̅ | 1 |
| | bᵢ | | | | bᵢ | | | | yᵢ | | | | yᵢ | | | | y′ᵢ | | | |
| 1 | 0 | 0 | l̅ | 1 | 0 | 0 | 1 | l̅ | 0 | 0 | 0 | 0 | 0 | 0 | l̅ | 1 | 0 | 0 | l̅ | 1 |
| | l̅ | l̅ | l̅ | 0 | l̅ | 1 | 0 | 0 | l | 0 | l̅ | 0 | l̅ | l̅ | 0 | 0 | l̅ | l̅ | l̅ | 0 |
| | 1 | 0 | 0 | 1 | 1 | l̅ | 0 | 0 | 1 | 0 | 0 | 1 | 1 | 1 | 0 | 0 | 1 | 1 | 0 | 1 |

In another example, the seventh-type ternary logic operator in Table 1 is selected, where (v, x)=(0, 1̅), and *=0. A truth table of the selected five ternary logic operators is Table 3. The five ternary logic operators are also referred to as S1, S2, J1, J2, and J3, and corresponding adders are referred to as SJ-MSD parallel adders.

TABLE 3
Ternary logic operator combinations that form an SJ-MSD parallel adder

| Type | Y operator (S1) | | | | F operator (S2) | | | | Y′ operator (J1) | | | | F′ operator (J2) | | | | S operator (J3) | | | |
|---|---|---|---|---|---|---|---|---|---|---|---|---|---|---|---|---|---|---|---|---|
| | aᵢ | 0 | l̅ | 1 | aᵢ | 0 | l̅ | 1 | fᵢ | 0 | l̅ | 1 | fᵢ | 0 | l̅ | 1 | f′ᵢ | 0 | l̅ | 1 |
| | bᵢ | | | | bᵢ | | | | yᵢ | | | | yᵢ | | | | y′ᵢ | | | |
| 7 | 0 | 0 | 0 | 1 | 0 | 0 | l̅ | l̅ | 0 | 0 | 1 | | 0 | 0 | l̅ | | 0 | 0 | l̅ | |
| | l̅ | 0 | l̅ | 0 | l̅ | l | 0 | 0 | l̅ | l̅ | 0 | | l | 0 | l̅ | | l̅ | l̅ | 0 | |
| | 1 | 1 | 0 | 1 | 1 | l | 0 | 0 | 1 | 1 | 0 | | 1 | 0 | 0 | | 1 | 1 | 0 | |

(2) Arrangement of Ternary Logic Operators

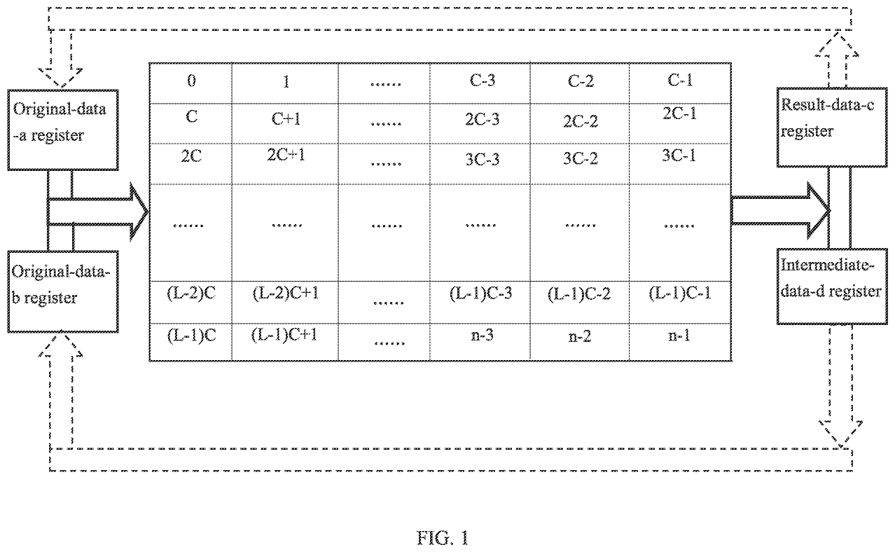

As shown in FIG. 1, during the first time of reconfiguration of a ternary operator, the 0^{th} operator bit to an (n−3)^{th} operator bit are configured into an (n−2)-bit Y operator. For data in an original-data-a memory and an original-data-b memory, n−2 bits are used as one group, the data is fed into a ternary operator group by group, to obtain a corresponding intermediate result py, and one 0 is added to the tail of py to form a first-type intermediate result y, which is stored in a calculation-result-c memory, until the data in the original-data-a memory and the original-data-b memory have all been calculated.

During the second time of reconfiguration of a ternary operator, the 0^{th} operator bit to an (n−3)^{th} operator bit are configured into an (n−2)-bit F operator. For data in an original-data-a memory and an original-data-b memory, n−2 bits are used as one group, the data is fed into a ternary operator group by group, to obtain a corresponding intermediate result pf, and one 0 is added to the head of pf to form a first-type intermediate result f, which is stored in an intermediate-result-d memory, until the data in the original-data-a memory and the original-data-b memory have all been calculated.

Next, content in the calculation-result-c memory is transferred to the original-data-a memory, and content in the intermediate-result-d memory is transferred to the original-data-b memory.

During the third time of reconfiguration of a ternary operator, the 0^{th} operator bit to an (n−2)^{th} operator bit are configured into an (n−1)-bit Y′ operator. For data in an original-data-a memory and an original-data-b memory, n−1 bits are used as one group, the data is fed into a ternary operator group by group, to obtain a corresponding intermediate result py′, and one 0 is added to the tail of py′ to form a second-type intermediate result y′, which is stored in a calculation-result-c memory, until the data in the original-data-a memory and the original-data-b memory have all been calculated.

During the fourth time of reconfiguration of a ternary operator, the 0^{th} operator bit to an (n−2)^{th} operator bit are configured into an (n−1)-bit F′ operator. For data in an original-data-a memory and an original-data-b memory, n−1 bits are used as one group, the data is fed into a ternary operator group by group, to obtain a corresponding intermediate result pf′, and one 0 is added to the head of pf′ to form a second-type intermediate result f′, which is stored in an intermediate-result-d memory, until the data in the original-data-a memory and the original-data-b memory have all been calculated.

Content in the calculation-result-c memory is transferred to the original-data-a memory again; and content in the intermediate-result-d memory is transferred to the original-data-b memory.

During the fifth time of reconfiguration of a ternary operator, the 0^{th} operator bit to an (n−1)^{th} operator bit are configured into an n-bit S operator. For data in an original-data-a memory and an original-data-b memory, n−1 bits are used as one group, the data is fed into a ternary operator group by group, to obtain a corresponding calculation result s, which is stored in a calculation-result-c memory, until the data in the original-data-a memory and the original-data-b memory have all been calculated.

The calculation-result-c memory outputs the calculation result s.

The adder has n−2 bits: Input data has n−2 bits, and output data has n bits.

In FIG. 1, a ternary operator has n operator bits, arranged into L rows and C columns, and a dash line represents an intermediate-result transmission channel.

A process of reconfiguring a ternary operator five times is as follows:

During the first time of reconfiguration, the 0^{th} ternary operator bit to an (n−3)^{th} ternary operator bit are formed into a Y operator.

During the second time of reconfiguration, the 0^{th} ternary operator bit to an (n−3)^{th} ternary operator bit are formed into an F operator.

During the third time of reconfiguration, the 0^{th} ternary operator bit to an (n−2)^{th} ternary operator bit are formed into a Y′ operator.

During the fourth time of reconfiguration, the 0^{th} ternary operator bit to an (n−2)^{th} ternary operator bit are formed into an F′ operator.

During the fifth time of reconfiguration, the 0^{th} ternary operator bit to an (n−1)^{th} ternary operator bit are formed into an S operator.

An intermediate-result transmission channel between memories that is represented by a dash line in FIG. 1 is a common technology in the current computer field. Details are not described herein.

(3) Physical Properties of a Ternary Operator:

According to the decrease-radix design principle (reference may be made to Chinese Invention Patent ZL200710041144.1), a no-light state and two orthogonally polarized light states are used to express information, and a ternary logic optical operator is configured by using a polarization rotator and a polarizer. For the specific structure, reference may be made to Chinese Invention Patent ZL201010584129.3. The polarization rotator may be a liquid-crystal array, a lithium niobate crystal array or a pixel array formed by another optical rotation material. An optical MSD parallel adder is configured by using such ternary operators.

According to the decrease-radix design principle (reference may be made to Chinese Invention Patent ZL200710041144.1), a ternary electronic operator is configured by using a digital circuit, including a ternary logic-electronic operator with a ternary symbol using two-dimensional binary expression and a ternary logic-electronic operator with a one-dimensional ternary symbol completed by a potential combiner. For the specific structure, reference may be made to Chinese Invention Patent Application 201811567284.7 or PCT/CN2019/070318. An electronic MSD parallel adder is configured by using such a ternary operator.

Embodiment 2: Method for implementing an MSD parallel adder by reconfiguring a ternary operators three times

(1) A Ternary Logic Operator that Satisfies a Sufficient Condition for MSD Addition is Selected:

It is the same with Embodiment 1.

(2) Arrangement of Ternary Logic Operators

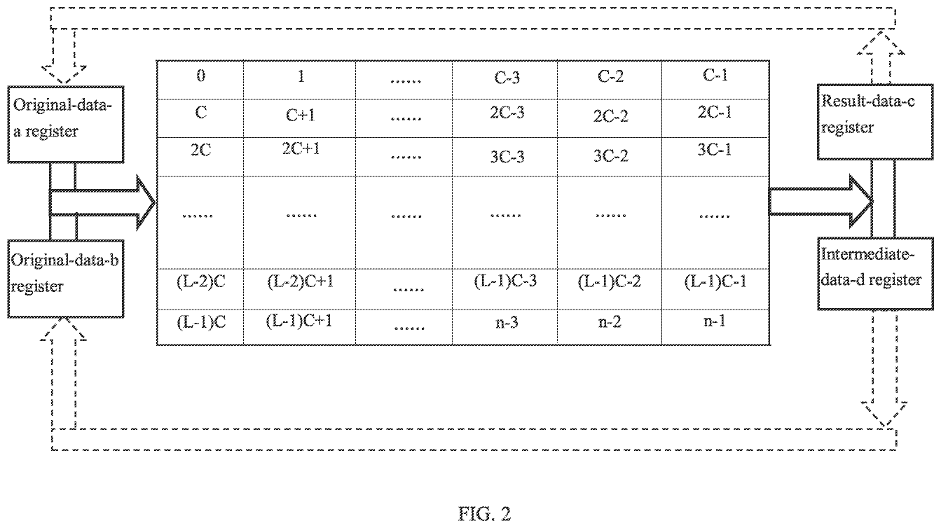

As shown in FIG. 2, n ternary operator bits are equally divided into two parts. One part of an operator bit order is the 0^{th} ternary operator bit to an ((n/2)−1)^{th} ternary operator bit, and is referred to as a low-bit order part. The other part of the operator bit order is an (n/2)^{th} ternary operator bit to an (n−1)^{th} ternary operator bit, and is referred to as a high-bit order part.

During the first time of reconfiguration of a ternary operator, the 0^{th} operator bit to an ((n/2)−3)^{th} operator bit in the low-bit order part are configured into an ((n/2)−2)-bit Y operator, an (n/2)^{th} operator bit to an (n−3)^{th} operator bit in the high-bit order part are configured into an ((n/2)−2)-bit F operator, or the locations of the Y operator and the F operator are exchanged. For data in an original-data-a memory and an original-data-b memory, (n/2)−2 bits are used as one group, and the data is fed into both the Y operator and the F operator group by group. The first-type intermediate result py is obtained from the Y operator, one 0 is added behind py, and py added with 0 is stored in a calculation-result-c memory. At the same time, the first-type intermediate result pf is obtained at the F operator, one 0 is added in front of pf, and pf added with 0 is stored in an intermediate-result-d memory, until the data in the original-data-a memory and the original-data-b memory have all been calculated.

Next, content in the calculation-result-c memory is transferred to the original-data-a memory; and content in the intermediate-result-d memory is transferred to the original-data-b memory.

During the second time of reconfiguration of a ternary operator, the 0^{th} operator bit to an ((n/2)−2)^{th} operator bit in the low-bit order part are configured into an ((n/2)−1)-bit Y′ operator, an (n/2)^{th} operator bit to an (n−2)^{th} operator bit in the high-bit order part are configured into an ((n/2)−1)-bit F′ operator, or the locations of the Y′ operator and the F′ operator are exchanged. For data in an original-data-a memory and an original-data-b memory, (n/2)−1 bits are used as one group, and the data is fed into both the Y° operator and the F′ operator group by group. The second-type intermediate result py′ is obtained from the Y′ operator, one 0 is added behind py′, and py′ added with 0 is stored in a calculation-result-c memory. At the same time, the second-type intermediate result pf′ is obtained at the F′ operator, one 0 is added in front of pf′, and pf′ added with 0 is stored in an intermediate-result-d memory, until the data in the original-data-a memory and the original-data-b memory have all been calculated.

Next, content in the calculation-result-c memory is transferred to the original-data-a memory, and content in the intermediate-result-d memory is transferred to the original-data-b memory.

During the third time of reconfiguration of a ternary operator, the 0^{th} operator bit to an ((n/2)−1)^{th} operator bit in the low-bit order part are configured into an (n/2)-bit S operator. For data in an original-data-a memory and an original-data-b memory, n/2 bits are used as one group, and the data is fed into an S operator group by group, to obtain a final result s, which is stored in a calculation-result-c memory.

The calculation-result-c memory outputs the calculation results.

The adder has (n/2)−2 bits: Input data has (n/2)−2 bits, and output data has n/2 bits.

In FIG. 2, a ternary operator has n operator bits, arranged into L rows and C columns, and a dash line represents an intermediate-result transmission channel.

A process of reconfiguring a ternary operator three times is as follows:

During the first time of reconfiguration: The 0^{th} ternary operator bit to an (n/2−3)^{th} ternary operator bit are formed into a Y operator, and an (n/2)^{th} ternary operator bit to an (n−3)^{th} ternary operator bit are formed into an F operator.

During the second time of reconfiguration: The 0^{th} ternary operator bit to an (n/2−2)^{th} ternary operator bit are formed into a Y′ operator, and an (n/2)^{th} ternary operator bit to an (n−2)^{th} ternary operator bit are formed into an F′ operator.

During the third time of reconfiguration, the 0^{th} ternary operator bit to an (n/2−1)^{th} ternary operator bit are formed into an S operator.

An intermediate-result transmission channel between memories that is represented by a dash line in FIG. 2 is a common technology in the current computer field. Details are not described herein.

(3) Physical Properties of an Operator:

It is the same with Embodiment 1. Details are not described again herein.

Embodiment 3: Method 1 for implementing an MSD parallel adder by reconfiguring the ternary operators once

(1) A Ternary Logic Operator that Satisfies a Sufficient Condition for MSD Addition is Selected:

It is the same with Embodiment 1.

(2) Arrangement of Ternary Logic Operators

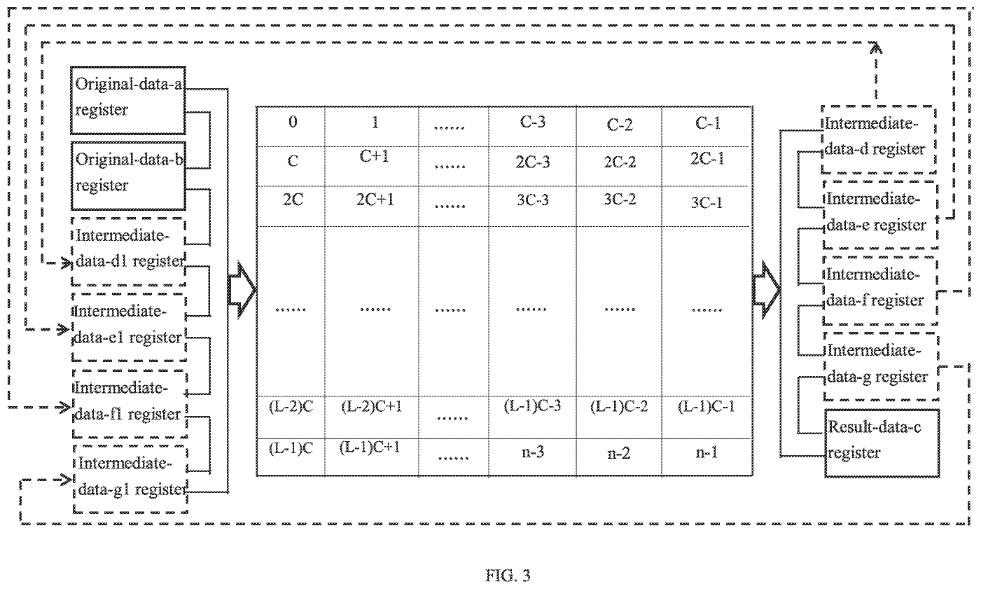

As shown in FIG. 3, if the configured adder has m bits, the used ternary operator has n operator bits. When n is not less than 5×m+4, five ternary logic operators Y, F, Y′, F′, and S may be reconfigured once at different locations of the ternary operator. The original data is then fed piece by piece into the ternary operator to perform “data pipeline” calculation.

A method for reconfiguring a ternary operator is as follows:

The part of the 0^{th} bit to an (m−1)^{th} bit of an operator bit order are configured into an m-bit Y operator, the part of an m^{th} bit to a (2m−1)^{th} bit of the operator bit order are configured into an m-bit F operator, the part of a 2m^{th} bit to a 3m^{th} bit of the operator bit order are configured into an (m+1)-bit Y′ operator, the part of a (3m+1)^{th} bit to a (4m+1)^{th} bit of the operator bit order are configured into an (m+1)-bit F′ operator, and the part of a (4m+2)^{th} bit to a (5m+4)^{th} bit of the operator bit order are configured into an (m+2)-bit S operator.

At the first clock, the first pair of values of the original data a and b are fed into the Y operator and the F operator of the ternary operator, and one 0 is added behind the first-type intermediate result py outputted by the Y operator, and one 0 is added in front of the first-type intermediate result data pf outputted by the F operator, to obtain the first pair of values y1 and f1 of the first-type intermediate calculation result.

There are three methods for transferring y1 and f1 to the input terminals of the Y′ operator and the F′ operator: 1) y1 and f1 are transferred through a direct connection using a communication line. 2) y1 and f1 are respectively stored in an intermediate-result-d register and an intermediate-result-e register, and are respectively fed into the input terminals of the Y′ operator and the F′ operator from the d register and the e register. 3) y1 and f1 are stored in the intermediate-result-d register and the intermediate-result-e register, are fed into a corresponding intermediate-result-d1 register and a corresponding intermediate-result-e1 register from the d register and the e register, and are then respectively fed into the input terminals of the Y′ operator and the F′ operator from the d1 register and the e1 register.

At the second clock, the second pair of values of the original data a and b are fed into the Y operator and the F operator of the ternary operator, one 0 is added behind the intermediate result data py outputted by the Y operator, and one 0 is added in front of the intermediate result data pf outputted by the F operator, to obtain the second pair of values y2 and f2 of the first-type intermediate calculation result. At the same time, the first pair of values y1 and f1 of the first-type intermediate calculation result are fed into the Y′ operator and the F′ operator, and one 0 is added behind the second-type intermediate result data py′ outputted by the Y′ operator, and one 0 is added in front of the second-type intermediate result data pf′ outputted by the F′ operator, to obtain the first pair of values y′1 and f′1 of the second-type intermediate calculation result.

A method for transferring y2 and f2 to the input terminals of the Y′ operator and the F′ operator is the same as that for transferring y1 and f1.

There are also three methods for transferring y′1 and f′1 to the input terminals of the S operator: 1) y′1 and f′1 are transferred through a direct connection using a communication line. 2) y′1 and f′1 are respectively stored in an intermediate-result-f register and an intermediate-result-g register, and are respectively fed into the input terminal of the S operator from the f register and the g register. 3) y′1 and f′1 stored in the intermediate-result-f register and the intermediate-result-g register, are fed into a corresponding intermediate-result-f1 register and a corresponding intermediate-result-g1 register from the f register and the g register, and are then respectively fed into the input terminal of the S operator from the f1 register and the g1 register.

At the third clock, the third pair of values of the original data a and b are fed into the Y operator and the F operator of the ternary operator, one 0 is added behind the intermediate result data py outputted by the Y operator, and one 0 is added in front of the intermediate result data pf outputted by the F operator, to obtain the third pair of values y3 and f3 of the first-type intermediate calculation result. At the same time, the second pair of values y2 and f2 of the first-type intermediate calculation result are fed into the Y′ operator and the F′ operator, and one 0 is added behind the second-type intermediate result data py′ outputted by the Y′ operator, and one 0 is added in front of the second-type intermediate result data pf outputted by the F′ operator, to obtain the second pair of values y′2 and f′2 of the second-type intermediate calculation result. At the same time, the first pair of values y′1 and f′1 of the second-type intermediate calculation result are fed into the S operator, and S outputs the first value s1 of a calculation result.

A method for transferring y3 and f3 to the input terminals of the Y′ operator and the F′ operator is the same as that for transferring y1 and f1. A method for transferring y′2 and f′2 to the input terminal of the S operator is the same as that for transferring y′1 and f′1. s1 is stored in the calculation-result-c register.

Working processes of an operator at subsequent clocks are identical with that at the third clock. The original data enters the Y operator and the F operator piece by piece. After three clocks, a corresponding calculation result value is outputted from S.

In FIG. 3, a ternary operator has n operator bits, arranged into L rows and C columns, and a dash line represents an intermediate-result transmission channel.

Eight dash-line boxes represent that there may be or may be not eight intermediate-results registers. There may be no d1, e1, f1, and g1 in some devices, and intermediate results respectively directly transferred from memories d, e, f, and g. There may be none of the eight intermediate registers, and intermediate results respectively outputted by the Y operator and the F operator to the Y′ operator and the F′ operator, and outputs of the Y′ operator and the F′ operator are directly fed into the input terminal of the S operator.

Suppose one is to build an m-bit MSD adder where n≥5m+4, the process of reconfiguring a ternary operator is as follows:

An m-bit Y operator is configured on the 0^{th} operator bit to an (m−1)^{th} operator bit.

An m-bit F operator is configured on an m^{th} operator bit to a (2m−1)^{th} operator bit.

An (m+1)-bit Y′ operator is configured at a 2m^{th} operator bit to a m^{th} operator bit.

An (m+1)-bit F′ operator is configured at a (3m+1)^{th} operator bit to a (4m+1)^{th} operator bit.

An (m+2)-bit S operator is configured at a (4m+2)^{th} operator bit to a (5m+4)^{th} operator bit.

(3) Physical Properties of an Operator:

It is the same with Embodiment 1. Details are not described again herein.

Embodiment 4: Configuration of an MSD parallel adder according to data bits

(1) A Ternary Logic Operator that Satisfies a Sufficient Condition for MSD Addition is Selected:

It is the same with Embodiment 1.

(2) Arrangement of Ternary Logic Operators

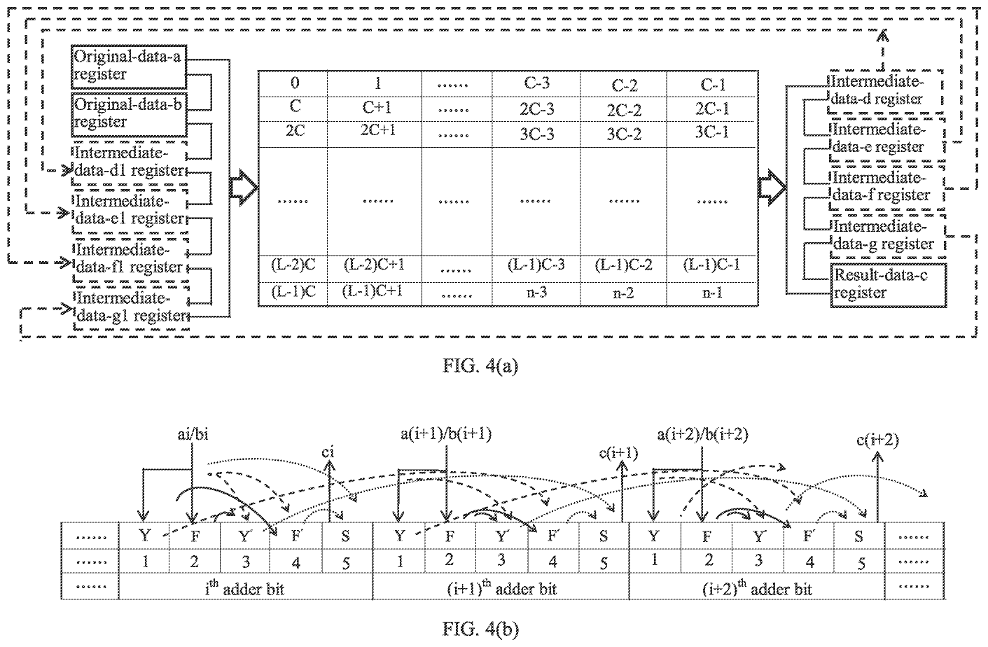

As shown in FIG. 4, if a quantity of data bits of adder is m, which are numbered 0, 1, . . . , m-1, the used ternary operator has n operator bits, which are numbered 0, 1, . . . , n−1. When n is not less than 5×(m+2), any five operator bits form one adder bit, and a total of m+2 adder bits are obtained, which are numbered 0, 1, . . . , m+1. Bit sequence numbers of five operator bits included in each adder bit do not need to be consecutive. However, when five operator bits with consecutive bit sequence numbers are used, the configuration and use of an adder may be slightly more convenient. The adder bits have the same structure. Specifically, the Y operator is configured at the first bit, the F operator is configured at the second bit, the Y′ operator is configured at the third bit, the F′ operator is configured at the fourth bit, and the S operator is configured at the fifth bit, as shown in FIG. 4(a). The ternary logic operators may be configured on other operator bits of the adder bit.

At the first clock, respective m bits of the first pair of values of the original data a and b are respectively fed into Y operators and F operators of the 0^{th} adder bit to the (m−1)th adder bit. Respective m bits of the first pair of values py1 and pf1 of the first-type intermediate calculation result are obtained.

At the second clock, respective m bits of the second pair of values of the original data a and b are respectively fed into Y operators and F operators of the 0^{th} adder bit to the (m−1)th adder bit, to obtain respective m bits of the second pair of values py2 and pf2 of the first-type intermediate calculation result. At the same time, the py1 value of the first-type intermediate calculation result of an i^{th} adder bit and the pf1 value of the first-type intermediate calculation result of an (i+1)^{th} adder bit are fed into the Y′ operator and the F′ operator of an (i+1)^{th} adder bit, where i=0, 1, 2, . . . , m−2. Input values of the Y′ operator and the F′ operator of the lowest bit (the 0^{th} bit) of the adder are respectively 0 and the pf1 value of the adder of the bit, input values of the Y′ operator and the F′ operator of the second highest bit (an m^{th} bit) of the adder are respectively 0 and the py1 value of the adder of an (m−1)^{th} bit, and respective m+1 bits of the first pair of values py′1 and pf′1 of the second-type intermediate calculation result are respectively obtained by using the Y′ operator and the F′ operator.

At the third clock, respective m bits of the third pair of values of the original data a and b are respectively fed into Y operators and F operators of the 0^{th} adder bit to an mth adder bit, to obtain the respective m bits of the third pair of values py3 and pf3 of the first-type intermediate calculation result. At the same time, the py2 value of the first-type intermediate calculation result of an i^{th} adder bit and the pf2 value of the first-type intermediate calculation result of an (i+1)th adder bit are fed into the Y′ operator and F′ operator of an (i+1)^{th} adder bit, where i=0, 1, 2, . . . , m−2. Input values of the Y′ operator and the F′ operator of the lowest bit (the 0^{th} bit) of the adder are respectively 0 and the pf2 value of the adder of the bit, input values of the Y′ operator and the F′ operator of the second highest bit (an m^{th} bit) of the adder are respectively 0 and the py2 value of the adder of an (m−1)^{th} bit, and respective m+1 bits of the first pair of values py′2 and pf′2 of the second-type intermediate calculation result are respectively obtained by using the Y′ operator and the F′ operator. At the same time, the py′1 value of the second-type intermediate calculation result of an i^{th} adder bit and the pf′1 value of the second-type intermediate calculation result of an (i+1)^{th} adder bit are fed into an S operator of an (i+1)^{th} adder bit, where i=0, 1, 2, . . . , m−1. Input values of the S operator of the lowest bit (the 0^{th} bit) of the adder are respectively 0 and the pf′1 value of the bit adder, input values of the S operator of the highest bit (an (m+1)^{th} bit) of the adder are 0 and the py′1 value at an m^{th}-bit adder, and the S operators of the adder bits output m+2 bits of a final calculation result s.

Working processes of a ternary operator at subsequent clocks are identical with that at the third clock. The original data enters Y operators and F operators of the adder bits piece by piece. After three clocks, a corresponding calculation result value is outputted from S operators of the adder bits.

During the use of the structure in which ternary logic operators of data bits of an MSD parallel adder shown in FIG. 4(b) are directly connected, the foregoing three clocks may be reduced to one clock.

In FIG. 4, a ternary operator has n operator bits, arranged into L rows and C columns, and a dash line represents an intermediate-result transmission channel.

In FIG. 4(a), eight dash-line boxes represent that there may be or may be not eight intermediate-number registers or memories. There may be no d1, e1, f1, and g1 in some MSD adders, and intermediate results are respectively directly transferred from registers or memories d, e, f, and g. There may be none of the eight intermediate registers or memories, and intermediate results respectively outputted by the Y operator and the F operator are fed into the input terminals of the Y′ operator and the F′ operator, and outputs of the Y′ operator and the F′ operator are directly fed into the input terminal of the S operator, as shown in FIG. 4(b).

FIG. 4(b) schematically shows a case of a direct connection for transferring intermediate results between data bits of adder. An output terminal of a Y operator of an i^{th} adder bit is directly connected to one input terminal of a Y′ operator and one input terminal of an F′ operator of a next higher bit (an (i+1)^{th} bit) of the adder. An output terminal of an F operator of an i^{th} adder bit is directly connected to another input terminal of a Y′ operator and another input terminal of an F′ operator of a current bit of the adder. An output terminal of a Y′ operator of an i^{th} bit is directly connected to one input terminal of an S operator of a next higher bit (an (i+1)^{th} bit) of the adder. An output terminal an F′ operator of an i^{th} bit is directly connected to another input terminal of an S operator of the current bit of the adder. Input terminals of a Y operator and an F operator of an i^{th} bit are both connected to an bit (ai and bi) of the inputted data. An S operator of an i^{th} bit outputs an i^{th} bit (ci) of a calculation result. Two input terminals of a Y′ operator and two input terminals of an F′ operator of the 0^{th} adder bit are respectively connected to a constant 0-value terminal and an output terminal of the F operator of the 0^{th} bit. Two input terminals of an S operator of an (m+2)^{th} adder bit are respectively connected to a constant 0-value terminal and an output terminal of a Y′ operator of an (m+1)^{th} bit, where i=0, 1, 2, . . . , m+1.

Suppose one is to build an m-bit MSD adder where n≥5(m+2), the process of reconfiguring a ternary operator is as follows. Every five operator bits are configured into a 1-bit MSD parallel adder, and there are adders of a total of m+2 bits. In an adder of each bit: a Y operator is configured at the first operator bit, an F operator is configured at the second operator bit, a Y° operator is configured at the third operator bit, an F′ operator is configured at the fourth operator bit, and an S operator is configured at the fifth operator bit.

(3) Physical Properties of an Operator:

It is the same with Embodiment 1. Details are not described again herein.

Embodiment 5: Method for reducing the quantity of occupied operator bits of an SJ-MSD parallel adder

(1) A Ternary Logic Operator that Satisfies a Sufficient Condition for MSD Addition is Selected:

The seventh-type ternary logic operator in Table 1 is selected, where (v, x)=(0, 1̅), and *=0. A truth table of the selected five ternary logic operators is Table 3.

In Table 3, J2 operators all have outputs of 0 when yi=0, have no output when yi=1, and only have non-0 outputs when yi=1̅. For a ternary logic optical operator, a light status is dark when there is no output, which is the same as a light status when a 0 value is outputted. For a ternary logic electronic operator, an electrical status is 00 when there is no output, which is also the same as an electrical status when a 0 value is outputted. Therefore, in cases of the two ternary logic operators, a truth table of a J2 operator may be changed to only one column of yi=1̅. Further, a physical state representing an 1̅ value in the J2 operator is replaced with a physical state representing a 1 value in the J1 operator, so that the J2 operator may be combined with the J1 operator for configuration at one adder bit. As shown in Table 4, in this case, each bit of an SJ-MSD adder only needs to occupy four operator bits.

TABLE 4
Combination of J2 and J1
Y′ operator (J1/J2)

| | fᵢ | | |
|---|---|---|---|
| yᵢ | 0 | \|̅ | 1 |
| 0 | 0 | 1 | \|̅ |
| \|̅ | \|̅ | 0 | \|̅ |
| 1 | 1 | 0 | 0 |

(2) Arrangement of Ternary Logic Operators

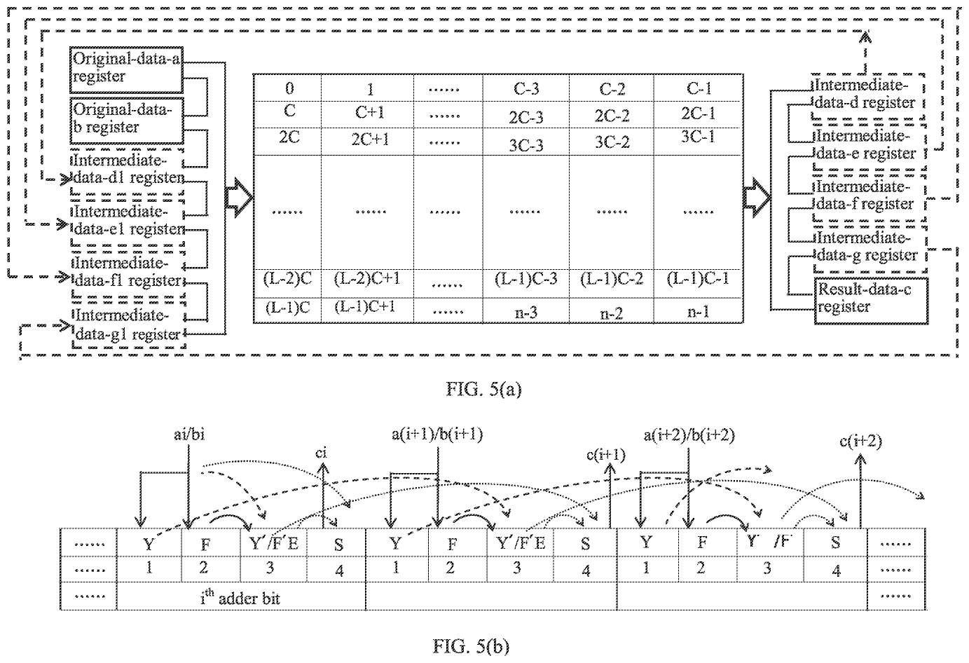

As shown in FIG. 5, if a quantity of data bits of adder is m, which are numbered 0, 1, . . . , m−1, the used ternary operator has n operator bits, which are numbered 0, 1, . . . , n−1. When n is not less than 4×(m+2), any four operator bits form one adder bit, and a total of m+2 adder bits are obtained, which are numbered 0, 1, . . . , m+1. The adder bits have the same structure. Specifically, the Y operator is configured at the first bit, the F operator is configured at the second bit, the Y′ operator and the F′ operator are configured at the third bit, and the S operator is configured at the fourth bit.

At the first clock, respective m bits of the first pair of values of the original data a and b are respectively fed into Y operators and F operators of the 0^{th} adder bit to an mth adder bit. Respective m bits of the first pair of values py1 and pf1 of the first-type intermediate calculation result are obtained.

At the second clock, respective m bits of the second pair of values of the original data a and b are respectively fed into Y operators and F operators of the 0^{th} adder bit to the (m−1)^{th} adder bit, to obtain respective m bits of the second pair of values py2 and pf1 of the first-type intermediate calculation result. At the same time, the py1 value of the first-type intermediate calculation result of an adder bit and the pf1 value of the first-type intermediate calculation result of an (i+1)^{th} adder bit are fed into the Y′ operator of an (i+1)^{th} adder bit, and the pf1 value undergoes negate, i.e. 1 and 1̅ are swapped, 0 stays the same, before being transferred into the F′ operator of an (i+1)^{th} adder bit, where i=0, 1, 2, . . . , m−2. Input values of the Y operator of the lowest bit (the 0^{th} bit) of the adder are respectively 0 and the pf1 value, and input values of the F′ operator of the lowest bit of the adder are respectively 0 and the negate value of pf1 of the adder of the bit; Input values of the Y′ operator and the F′ operator of the second highest bit (an mth bit) of the adder are respectively 0 and the pyl value of the adder of an (m−1)th bit, and respective m+1 bits of the first pair of values py′1 and pf′1 of the second-type intermediate calculation result are respectively obtained by using the Y′ operator and the F′ operator.

At the third clock, respective m bits of the third pair of values of an original-data-a memory and an original-data-b memory are respectively fed into Y operators and F operators of the 0^{th} adder bit to an mth adder bit, to obtain the respective m bits of the third pair of values py3 and pf3 of the first-type intermediate calculation result. At the same time, the py2 value of the first-type intermediate calculation result of an i^{th} adder bit and the pf2 value of the first-type intermediate calculation result of an (i+1)^{th} adder bit are fed into the Y′ operator of an (i+1)^{th} adder bit, and the pf2 value undergoes negate before being transferred to the F′ operator of an (i+1)^{th} adder bit, where i=0, 1, 2, . . . , m−2. Input values of the Y′ operator of the lowest bit (the 0^{th} bit) of the adder are respectively 0 and the pf1 value, and input values of the F′ operator of the lowest bit of the adder are respectively 0 and the negate value of pf1 of the adder of the bit. Input values of the Y′ operator and the F′ operator of the second highest bit (an m^{th} bit) of the adder are respectively 0 and the py2 value of the adder of an (m−1)^{th} bit, and respective m+1 bits of the second pair of values py′2 and pf′2 of the second-type intermediate calculation result are respectively obtained by using the Y′ operator and the F′ operator. At the same time, the py′1 value of the second-type intermediate calculation result of an i^{th} adder bit and the pf′1 value of the second-type intermediate calculation result of an (i+1)^{th} adder bit are fed into an S operator of an (i+1)^{th} adder bit, where i=0, 1, 2, . . . , m−1. Input values of the S operator of the lowest bit (the 0^{th} bit) of the adder are respectively 0 and the pf′1 value of the bit adder, input values of the S operator of the highest bit (an (m+1)^{th} bit) of the adder are 0 and the py′1 value at an mth-bit adder, and the S operators of the adder bits output m+2 bits of a final calculation result s.

Working processes of a ternary operator at subsequent clocks are identical with that at the third clock. The original data enters Y operators and F operators of the adder bits piece by piece. After three clocks, a corresponding calculation result value is outputted from S operators of the adder bits.

During the use of the structure in which ternary logic operators of data bits of an MSD parallel adder are directly connected shown in FIG. 5(b), the foregoing three clocks may be reduced to one clock.

In FIG. 5, a ternary operator has n operator bits, arranged into L rows and C columns, and a dash line represents an intermediate-result transmission channel.

In FIG. 5(a), eight dash-line boxes represent that there may be or may be not eight intermediate-number registers or memories. There may be no dl, el, fl, and gl in some MSD adders, and intermediate results are respectively directly transferred from registers or memories d, e, f, and g. There may be none of the eight intermediate registers or memories, and intermediate resultis respectively outputted by the Y operator and the F operator to the Y′ operator and the F′ operator, and outputs of the Y′ operator and the F′ operator are directly fed into the input terminal of the S operator, as shown in FIG. 5(b).

FIG. 5(b) schematically shows a case of a direct connection for transferring intermediate results between data bits of adder. An output terminal of a Y operator of an ith adder bit is directly connected to one input terminal of a Y′ operator/an F′ operator of a next higher bit (an (i+1)^{th} bit). An output terminal of an F operator of an i^{th} bit is directly connected to another input terminal of a Y′ operator/an F′ operator of a current bit. An output terminal of a Y′ operator of an ^{ith} bit is directly connected to one input terminal of an S operator of a next higher bit (an (i+1)^{th} bit). An output terminal an F′ operator of an ith bit is directly connected to another input terminal of an S operator of the current bit. Input terminals of a Y operator and an F operator of an 1^{th} bit are both connected to an i^{th} bit (ai and bi) of the inputted data. An S operator of an i^{th} bit outputs an i^{th} bit (ci) of a calculation result. Two input terminals of a Y′ operator of the 0^{th} adder bit are respectively connected to 0-value terminal and an output terminal of the F operator of the 0^{th} bit, and two input terminals of an F′ operator of the 0^{th} adder bit are respectively connected to 0-value terminal and negate of an output terminal of the F operator of the 0^{th} bit. Two input terminals of an S operator of an (m+2)^{th} adder bit are respectively connected to a 0-value terminal and an output terminal of a Y′ operator of an (m+1)^{th} bit, where i=0, 1, 2, . . . , m+1.

Suppose one is to build an m-bit SJ-MSD parallel adder where n≥4(m+2), the process of reconfiguring a ternary operator is as follows. Every four operator bits are configured into a 1-bit SJ-MSD parallel adder, and there are adders of a total of m+2 bits. In an adder of each bit: a Y operator is configured at the first operator bit, an F operator is configured at the second operator bit, a Y′ operator and an F′ operator are configured at the third operator bit, and an S operator is configured at the fourth operator bit.

(3) Physical Properties of an Operator:

It is the same with Embodiment 1. Details are not described again herein.

In the foregoing embodiments: Uppercase letters Y, F, Y′, F′, and S represent five different ternary logic operators or ternary logic operation rules. Lowercase letters py, pf, py′, and pf′ respectively represent data (operational results) outputted by the ternary logic operators Y, F, Y′, and F′. Lowercase letters y, f, y′, and f′ are data (intermediate calculation results) obtained after Os are respectively added to py, pf, py′, and pf′. A lowercase letter s is outputted data of the ternary logic operator S, and is also a calculation result outputted by the adder.

In the method for configuring an MSD parallel adder based on ternary logic operators provided in the embodiment of this invention, ternary logic operators that satisfy a sufficient condition for MSD addition are used. When reconfigurable ternary operators are used to configure such an MSD parallel adder: a ternary operator may be reconfigured into a ternary logic operator each time, and an adder is implemented after five times of reconfiguration; two ternary logic operators having the same input may be reconfigured on ternary operator each time, and an adder is implemented after three times of reconfiguration; and five ternary logic operators may be reconfigured at the same time on a ternary operator, and an adder is implemented after one time of reconfiguration. Unreconfigurable corresponding ternary logic operators may be used instead for the foregoing reconfiguration process. The ternary logic operators may transfer intermediate result by using memories or registers. An output terminal of a former ternary logic operator may be directly connected to an input terminal of a latter ternary logic operator to transfer intermediate result. Memories in dash-line boxes in FIG. 1 to FIG. 5 represent that the memories or registers may be used to temporarily store and transfer intermediate result data, and intermediate result may be transferred by using a direct connection.

Based on the method for configuring an MSD parallel adder using ternary logic operators provided in the foregoing embodiments of this invention, an embodiment of this invention further provides an MSD parallel adder based on ternary logic operators. The MSD parallel adder based on ternary logic operators is configured by using any configuration method in the foregoing.

An embodiment of this invention further provides another MSD parallel adder based on ternary logic operators, including five ternary logic operators that satisfy the sufficient condition for MSD addition, where the sufficient condition for MSD addition is:

if for any two MSD numbers, namely, a=aₙ₋₁ . . . a₁a₀ and b=bₙ₋₁ . . . b₁b₀, Y, F, Y′, F′, and S are used to successively perform bit conversion, and the following four conditions are satisfied, an obtained number s=sₙ₊₁sₙ . . . s₁s₀ is a sum value of a and b, and s is an MSD number;

Condition 1: aᵢ+bᵢ=yᵢ₊₁×2+fᵢ, where i=0, 1, . . . , n−1; and y₀=fₙ=ϕ, where ϕ is an added 0;

Condition 2: yᵢ+fᵢ=y′ᵢ₊₁×f′ᵢ, where i=0, 1, . . . , n; and y′₀=f′ₙ₊₁=ϕ;

Condition 3: y′ᵢ+f′ᵢ=sᵢ, where i=0, 1, . . . , n+1; and

Condition 4: y′ᵢ and f′ᵢ are not 1 at the same time and are not i at the same time, where i=0, 1, . . . , n+1; and)

yᵢ, fᵢ, y′ᵢ, f′ᵢ, and sᵢ in the foregoing four conditions are respectively obtained from the following operations:

for aᵢ and bᵢ, Y conversion is performed to obtain yᵢ₊₁, and F conversion is performed to obtain fᵢ, where y=yₙyₙ₋₁ . . . y₂y₁ϕ, and f=ϕfₙ₋₁ . . . f₁f₀;

for yᵢ and fᵢ, Y′ conversion is performed to obtain y′ᵢ₊₁, and F′ conversion is performed to obtain f′ᵢ, where y′=y′ₙ₊₁y′ₙ . . . y′₃y′₂y′₁ϕ, and f′=ϕf′ₙf′ₙ₋₁ . . . f′₁f′₀; and

for y′ᵢ and f′ᵢ, S conversion is performed to obtain sᵢ, where s=sₙ₊₁sₙ . . . s₁s₀.

The MSD parallel adder based on ternary logic operators and method for configuring same provided in the foregoing embodiments of this invention have the following important features:

1. An MSD parallel adder is implemented by using a group of ternary logic operators that satisfy a sufficient condition for MSD addition.

The ternary logic operators that satisfy the sufficient condition for MSD addition include seven types provided in Table 1, but are not limited to the seven types. Any ternary logic operator in Table 1 or a ternary logic operator formed by transposing a truth table in Table 1 falls within the encompassed by this invention.

2. In the MSD parallel adder according to the embodiment of this invention, there is at most one carry to a next higher bit at each data bit, and there is no consecutive carry to a still next higher bit.

3. Input data and output data in the embodiments of this invention are both MSD numbers. It should be noted that conventional binary numbers are one specific example of MSD numbers and are also MSD numbers. Therefore, when the input data or output data is conventional binary data, and the scope encompassed by this invention cannot be narrowed down. Provided that the used operator satisfies the foregoing feature 1, a corresponding adder falls within the protection scope of this invention.

4. The MSD parallel adder in the embodiments of this invention is generally completed by using three operation steps, but may be completed by using more or fewer steps in some structures. Provided that the used operator satisfies the foregoing feature 1, the protection scope of this invention shall not be narrowed down because of the use of more or fewer operation steps:

In the first step, bits of original data a and bits of original data b are simultaneously fed into corresponding bits of a Y operator and corresponding bits of an F operator. The Y operator obtains an intermediate result py, and adds one 0 to the tail of py (it is not necessary to add 0 to the tail of py obtained by some Y operators) to obtain an intermediate result y. The F operator obtains an intermediate result pf, and adds one 0 in front of pf to obtain an intermediate result f.

In the second step, bits of the intermediate result y and bits of f are simultaneously fed into corresponding bits of a Y′ operator and corresponding bits of an F′ operator. The Y′ operator obtains an intermediate result py′, and adds one 0 to the tail of py′ (it is not necessary to add 0 to the tail of py′ obtained by some Y′ operators) to obtain an intermediate result y′. The F′ operator obtains an intermediate result pf′, and adds one 0 in front of pf′ to obtain an intermediate result f′.

In the third step, bits of the intermediate results y′ and f′ are simultaneously fed into bits of an S operator to obtain a calculation result s.

5. In the MSD parallel adder in the embodiment of this invention, an arrangement manner of five logic operators may have various forms. Several specific structures encompassed by this invention are provided in the embodiments of the Description. The structures of MSD parallel adder formed by the several specific structures or the division or combination thereof or simple variations thereof all fall within the scope of this invention.

Specific embodiments of this invention are described above. It should be understood that this invention is not limited to the foregoing specific implementations. A person skilled in the art may make various variations or modifications within the scope of the claims, and such variations or modifications do not affect the substantial content of this invention.

We claim:

1. A method for configuring a modified signed-bit (MSD) parallel adder based on ternary logic operators, wherein five ternary logic operators that satisfy a sufficient condition for MSD addition are used to configure an MSD parallel adder, and the sufficient condition for MSD addition is:
if for any two MSD numbers, namely, a=aₙ₋₁ . . . a₁a₀ and b=bₙ₋₁ . . . b₁b₀, five different ternary logic operation rules Y, F, Y′, F′, and S are used to successively perform bit conversion, and the following four conditions are satisfied, an obtained number s=sₙ₊₁sₙ . . . s₁s₀ is a sum value of a and b, and s is an MSD number;
Condition 1: aᵢ+bᵢ=yᵢ₊₁×2+fᵢ, wherein i=0, 1, . . . , n−1; and y₀=fₙ=ϕ, wherein ϕ represents an added 0;
Condition 2: yᵢ+fᵢ=y′ᵢ₊₁×2+f′ᵢ, wherein i=0, 1, . . . , n; and y′₀=f′ₙ₊₁=ϕ;
Condition 3: y′ᵢ+f′ᵢ=sᵢ, wherein i=0, 1, . . . , n+1; and
Condition 4: y′ᵢ and f′ᵢ are not 1 at the same time and are not 1̅ at the same time, wherein i=0, 1, . . . , n+1; and
yᵢ, fᵢ, y′ᵢ, f′ᵢ, and sᵢ in the foregoing four conditions are respectively obtained from the following operations:
for aᵢ and bᵢ, Y conversion is performed to obtain yᵢ₊₁, and for aᵢ and bᵢ, F conversion is performed to obtain fᵢ, wherein y=yₙyₙ₊₁ . . . y₂y₁ϕ, and f=ϕfₙ₋₁ . . . f₁f₀;
for yᵢ and fᵢ, Y′ conversion is performed to obtain y′ᵢ₊₁, and for yᵢ and fᵢ, F′ conversion is performed to obtain f′ᵢ, wherein y′=y′ₙ₊₁y′ₙ . . . y′₃y′₂y′₁ϕ, and f′=ϕf′ₙf′ₙ₋₁ . . . f′₁f′₀; and
for y′ᵢ and f′ᵢ, S conversion is performed to obtain sᵢ, wherein s=sₙ₊₁sₙ . . . s₁s₀.

2. The method for configuring an MSD parallel adder based on ternary logic operators according to claim 1, wherein each ternary logic operation rule corresponds to one ternary logic operator, and within the constraint of the four conditions, there are a total of seven groups of five ternary logic operators that can form an MSD parallel adder, as shown in the following table:

| Type | Y operator | | | | F operator | | | | Y′ operator | | | | F′ operator | | | | S operator | | | |
|---|---|---|---|---|---|---|---|---|---|---|---|---|---|---|---|---|---|---|---|---|
| | aᵢ | 0 | l̅ | 1 | aᵢ | 0 | l̅ | 1 | fᵢ | 0 | l̅ | 1 | fᵢ | 0 | l̅ | 1 | f′ᵢ | 0 | l̅ | 1 |
| | bᵢ | | | | bᵢ | | | | yᵢ | | | | yᵢ | | | | y′ᵢ | | | |
| 1 | 0 | 0 | l̅ | 1 | 0 | 0 | 1 | l̅ | 0 | 0 | v | t | 0 | 0 | x | w | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 2 | 0 | 0 | 0 | 1 | 0 | 0 | l̅ | l̅ | 0 | 0 | l̅ | 0 | 0 | 0 | 1 | 1 | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 3 | 0 | 0 | l̅ | 0 | 0 | 0 | 1 | 1 | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 4 | 0 | 0 | l̅ | 1 | 0 | 0 | 1 | l̅ | 0 | 0 | l̅ | 0 | 0 | 0 | 1 | 1 | 0 | 0 | l̅ | 1 |
| | l̅ | 0 | l̅ | 0 | l̅ | l̅ | 0 | 0 | l̅ | 0 | l̅ | 0 | l̅ | l̅ | 0 | 0 | l̅ | l̅ | * | 0 |
| | 1 | 1 | 0 | 1 | 1 | l̅ | 0 | 0 | 1 | 0 | 0 | 1 | 1 | 1 | 0 | 0 | 1 | 1 | 0 | * |
| 5 | 0 | 0 | l̅ | 1 | 0 | 0 | 1 | l̅ | 0 | 0 | 0 | 1 | 0 | 0 | l̅ | l̅ | 0 | 0 | l̅ | 1 |
| | l̅ | l̅ | l̅ | 0 | l̅ | 1 | 0 | 0 | l̅ | 0 | l̅ | 0 | l̅ | l̅ | 0 | 0 | l̅ | l̅ | * | 0 |
| | 1 | 0 | 0 | 1 | 1 | 1 | 0 | 0 | 1 | 0 | 0 | 1 | 1 | 1 | 0 | 0 | 1 | 1 | 0 | * |
| 6 | 0 | 0 | l̅ | 0 | 0 | 0 | 1 | 1 | 0 | 0 | | 1 | 0 | 0 | | l̅ | 0 | 0 | l̅ | 1 |
| | l̅ | l̅ | l̅ | 0 | l̅ | 1 | 0 | 0 | l̅ | 0 | | 0 | l̅ | l̅ | | 0 | | | | |
| | 1 | 0 | 0 | 1 | 1 | 1 | 0 | 0 | 1 | t | | 1 | 1 | w | | 0 | 1 | 1 | 0 | * |
| 7 | 0 | 0 | 0 | 1 | 0 | 0 | l̅ | l̅ | 0 | 0 | 1 | | 0 | 0 | l̅ | | 0 | 0 | l̅ | |
| | l̅ | 0 | l̅ | 0 | l̅ | l̅ | 0 | 0 | l̅ | X | 0 | | l̅ | v | l̅ | | l̅ | l̅ | * | |
| | 1 | 1 | 0 | 1 | 1 | l̅ | 0 | 0 | 1 | 1 | 0 | | 1 | 0 | 0 | | 1 | 1 | 0 | |

Note:
* may be 0, l̅ or 1;
(x, v) is (1, l̅) or (l̅, 0); and
(t, w) is (1, l̅), or (0, 1).

3. The method for configuring an MSD parallel adder based on ternary logic operators according to claim 1, wherein a method for configuring an MSD parallel adder by using five ternary logic operators that satisfy the sufficient condition for MSD addition comprises:
S1. selecting a group of ternary logic operation rules that satisfy the sufficient condition for MSD addition;
S2. configuring, according to the group of ternary logic operation rules selected in S1, a ternary logic operator sequence that satisfies the sufficient condition for MSD addition, comprising:
\textcircled{1} arranging an operation order for a group of ternary logic operators having a fixed function, and configuring a ternary logic operator sequence that satisfies the sufficient condition for MSD addition;
\textcircled{2} arranging an operation order for a group of ternary logic operators formed by performing a reconfiguration operation on ternary operators having an operation configuration function, and configuring a ternary logic operator sequence that satisfies the sufficient condition for MSD addition; and
S3. configuring MSD parallel adders with different physical properties according to the structure of the ternary logic operators that satisfy the sufficient condition for MSD addition determined in S2 and by using ternary operators with different physical properties.

4. The method for configuring an MSD parallel adder based on ternary logic operators according to claim 3, wherein in S2, a method for configuring, by using ternary operators, the ternary logic operator that satisfies the sufficient condition for MSD addition is any of the following:
\textcircled{1} sequentially configuring, by reconfiguring the ternary operators five times by using reconfigurable ternary operators of n bits, all operator bits of the ternary operators into five ternary logic operators that satisfy the sufficient condition for MSD addition;
\textcircled{2} arranging, by reconfiguring the ternary operators three times by using reconfigurable ternary operators, the ternary operators of n bits into five ternary logic operators that satisfy the sufficient condition for MSD addition, wherein during the first two times of reconfiguration, two halves of the bits of the ternary operators are respectively configured into two ternary logic operators with the same input data in the five ternary logic operators that satisfy the sufficient condition for MSD addition;
\textcircled{3} arranging, by reconfiguring the ternary operators once by using reconfigurable ternary operators of n bits, the ternary operators into five ternary logic operators that satisfy the sufficient condition for MSD addition, wherein during the reconfiguration, bits of the ternary operators are divided into five parts, and each part is configured into one of the five ternary logic operators that satisfy the sufficient condition for MSD addition;
\textcircled{4} configuring m+2 data bits of adder by using reconfigurable ternary operators of n bits to implement a parallel adder with m-bit input data, wherein m represents an assumed quantity of data bits for configuring an MSD parallel adder, each data bit of adder comprises five ternary operator bits, and each ternary operator bit is configured into one bit of one of the five ternary logic operators that satisfy the sufficient condition for MSD addition.

5. The method for configuring an MSD parallel adder based on ternary logic operators according to claim 4, wherein a method for configuring an MSD parallel adder by reconfiguring the ternary operators five times comprises:
setting that a ternary operator has n operator bits;
during the first time of reconfiguration, configuring n−2 operator bits of a ternary operator into an (n−2)-bit Y operator, wherein all original data is grouped according to n−2 bits, each group of data is converted by using a Y operator, and one 0 is added to the tail of a conversion result each time, to obtain various groups of data of first-type intermediate results y;
during the second time of reconfiguration, configuring n−2 operator bits of a ternary operator into an (n−2)-bit F operator, wherein all original data is grouped according to n−2 bits, each group of data is converted by using an F operator, and one 0 is added to the head of a conversion result each time, to obtain various groups of data of first-type intermediate results f;
during the third time of reconfiguration, configuring n−1 operator bits of a ternary operator into an (n−1)-bit Y′ operator, wherein all first-type intermediate results are grouped according to n−1 bits, each group of data is converted by using a Y′ operator, and one 0 is added to the tail of a conversion result each time, to obtain various groups of data of second-type intermediate results y′;
during the fourth time of reconfiguration, configuring n−1 operator bits of a ternary operator into an (n−1)-bit F′ operator, wherein all first-type intermediate results are grouped according to n−1 bits, each group of data is converted by using an F′ operator, and one 0 is added to the head of a conversion result each time, to obtain various groups of data of second-type intermediate results f′; and
during the fifth time of reconfiguration, configuring n operator bits of a ternary operator into an n-bit S operator, wherein all second-type intermediate results are grouped according to n bits, and each group of data is converted by using an S operator, to obtain an adder operational results.

6. The method for configuring an MSD parallel adder based on ternary logic operators according to claim 4, wherein a method for configuring an MSD parallel adder by reconfiguring the ternary operators three times comprises:
setting that a ternary operator has n operator bits, wherein the 0^{th} bit to an ((n/2)−1)^{th} bit are referred to as a low-bit order part, and an (n/2)^{th} bit to an (n−1)^{th} bit are referred to as a high-bit order part;
during the first time of reconfiguration, configuring n/2−2 operator bits in the low-bit order part of the ternary operator into an (n/2−2)-bit Y operator, and configuring n/2−2 operator bits in the high-bit order part into an (n/2−2)-bit F operator, wherein all original data is grouped according to n/2×2 bits, each group of data is converted by using both a Y operator and an F operator, and for each time of conversion, and one 0 is added to the tail of each output value of the Y operator and one 0 is added to the head of each output value of the F operator, to respectively obtain various groups of data of first-type intermediate results y and various groups of data of first-type intermediate results f;
during the second time of reconfiguration, configuring n/2−1 operator bits in the low-bit order part of the ternary operator into an (n/2−1)-bit Y′ operator, and configuring n/2−1 operator bits in the high-bit order part into an (n/2−1)-bit F′ operator, wherein the first-type intermediate results are grouped according to n/2−1 bits, each group of data is converted by using both a Y′ operator and an F′ operator, and one 0 is added to the tail of each output value of the Y′ operator and one 0 is added to the head of each output value of the F′ operator, to respectively obtain various groups of data of second-type intermediate results y′ and various groups of data of second-type intermediate results f′; and
during the third time of reconfiguration, configuring n/2 operator bits in the low-bit order part or the high-bit order part of the ternary operator into an n/2-bit S operator, wherein all the second-type intermediate results are grouped according to n/2 bits, and each group of data is converted by using an S operator, to obtain an adder operational result s.

7. The method for configuring an MSD parallel adder based on ternary logic operators according to claim 4, wherein a method for configuring an MSD parallel adder by reconfiguring the ternary operators once comprises:
setting that a ternary operator has n operator bits, wherein n is greater than or equal to 5m+4, and m represents an assumed quantity of data bits for configuring an MSD parallel adder;
during the reconfiguration, configuring the 0^{th} bit to an (m−1)^{th} bit of the ternary operator into a Y operator, configuring an mth bit to a (2m−1)^{th} bit of the ternary operator into an F operator, configuring a 2m^{th} bit to a 3m^{th} bit of the ternary operator into a Y′ operator, configuring a (3m+1)^{th} bit to a (4m+1)^{th} bit of the ternary operator into an F′ operator, and configuring a (4m+2)^{th} bit to a (5m+3)^{th} bit of a ternary operator into an S operator;
grouping all original data according to m bits, wherein each group of data is converted by using both a Y operator and an F operator, and for each time of conversion, one 0 is added to the tail of an output value of the Y operator and one 0 is added to the head of an output value of the F operator, to respectively obtain various groups of data of first-type intermediate results y and various groups of data of first-type intermediate results f;
converting all the groups of data of the first-type intermediate results by using both a Y′ operator and an F′ operator, wherein for each time of conversion, one 0 is added to the tail of an output value of the Y′ operator and one 0 is added to the head of an output value of the F′ operator, to respectively obtain various groups of data of second-type intermediate results y′ and various groups of data of second-type intermediate results f′; and
converting all the groups of data of the second-type intermediate results by using an S operator, to obtain an adder operational results.

8. The method for configuring an MSD parallel adder based on ternary logic operators according to claim 7, wherein in the ternary logic operators configured by reconfiguring the ternary operators once, an i^{th}-bit output terminal of a Y operator and an (i+1)^{th}-bit output terminal of an F operator are respectively connected to two (i+1)^{th}-bit input terminals of a Y′ operator and two (i+1)^{th}-bit input terminals of an F′ operator; one 0-value terminal and a 0^{th}-bit output terminal of an F operator are respectively connected to two 0^{th}-bit input terminals of a Y′ operator and two 0^{th}-bit input terminals of an F′ operator; one 0-value terminal and the highest-bit output terminal of a Y operator are respectively connected to two highest-bit input terminals of a Y′ operator and two highest-bit input terminals of an F′ operator; an i^{th}-bit output terminal of a Y′ operator and an (i+1)^{th}-bit output terminal of an F′ operator are respectively connected to two (i+1)^{th}-bit input terminals of an S operator; one 0-value terminal and a 0^{th}-bit output terminal of an F′ operator are respectively connected to two 0^{th}-bit input terminals of an S operator; and one 0-value terminal and a highest-bit output terminal of a Y′ operator are respectively connected to two highest-bit input terminals of an S operator.

9. The method for configuring an MSD parallel adder based on ternary logic operators according to claim 4, wherein m+2 data bits of adder are configured to implement an m-bit parallel adder, each data bit of adder comprises five ternary operator bits, the five ternary operator bits are respectively configured into one bit of five ternary logic operators, and a method for arranging ternary logic operators is implemented in each data bit of adder in the same manner, comprising:
setting that a ternary operator has n operator bits, wherein n is greater than or equal to 5(m+2);
reconfiguring any five operator bits of a ternary operator into one data bit of an MSD parallel adder, wherein m+2 data bits form an m-bit MSD parallel adder, and five operator bits in each data bit are respectively reconfigured into a Y operator, an F operator, a Y′ operator, an F′ operator, and an S operator;
simultaneously feeding an i^{th} bit of original data a and an i^{th} bit of original data b into a Y operator and an F operator of an i^{th} data bit of adder, wherein i=0, 1, 2, . . . , m−1; simultaneously feeding an output value of a Y operator of an i^{th} data bit and an output value of an F operator of an (i+1)^{th} data bit into two input terminals of a Y′ operator and two input terminals of an F′ operator of the (i+1)^{th} data bit; simultaneously feeding an output value of a Y′ operator of the i^{th} data bit and an output value of an F′ operator of the (i+1)^{th} data bit into two input terminals of an S operator of the (i+1)^{th} data bit; outputting, by an S operator of the i^{th} data bit, the value of an i^{th} bit of a calculation result; at the same time, feeding a 0 value and an output value of an F operator of the 0^{th} data bit into two input terminals of a Y′ operator and two input terminals of an F′ operator of the 0^{th} data bit; and feeding an 0-value terminal and an output terminal of an F′ operator of the 0^{th} bit into two input terminals of an S operator of the 0^{th} data bit; and
if an m^{th} data bit and an (m+1)^{th} data bit still comprise a Y operator, an F operator, a Y′ operator, and an F′ operator, feeding two 0 values into two input terminals of Y operators and two input terminals of F operators of the m^{th} data bit and the (m+1)^{th} data bit; if a Y operator and an F operator are omitted at the m^{th} data bit, feeding a 0 value and an output value of a Y operator of an (m−1)^{th} data bit into two input terminals of a Y′ operator and two input terminals of an F′ operator of the mth data bit; and if a Y operator, an F operator, a Y′ operator, and an F′ operator are omitted at the (m+1)^{th} data bit, feeding a 0 value and an output value of a Y′ operator of the mth data bit into two input terminals of an S operator of the (m+1)^{th} data bit.

10. The method for configuring an MSD parallel adder based on ternary logic operators according to claim 9, wherein in an MSD parallel adder arranged by configuring m+2 data bits of adder, an output terminal of a Y operator of each data bit of adder is directly connected to one input terminal of a Y′ operator and one input terminal of an F′ operator of a next higher bit, and an output terminal of an F operator of each data bit of adder is directly connected to another input terminal of a Y′ operator and another input terminal of an F′ operator of a current data bit of adder; an output terminal of a Y′ operator of each data bit of adder is directly connected to one input terminal of an S operator of a next higher data bit of adder, and an output terminal of an F′ operator of each data bit of adder is directly connected to another input terminal of the S operator of the current data bit of adder; at the same time, a 0-value terminal and an output terminal of the F operator of the 0^{th} data bit are connected to two input terminals of a Y′ operator and two input terminals of an F′ operator of the 0^{th} data bit, and a 0-value terminal and an output terminal of the F′ operator of the 0^{th} data bit of adder are connected to two input terminals of an S operator of the 0^{th} data bit of adder; a 0-value terminal and an output terminal of a Y operator of the third highest data bit are connected to two input terminals of a Y′ operator and two input terminals of an F′ operator of the second highest data bit of adder; a 0-value terminal and an output terminal of a Y′ operator of the second highest data bit of adder are connected to two input terminals of an S operator of the highest data bit of adder; and other ternary logic operators of the highest data bit do not have an output or do not work.

11. The method for configuring an MSD parallel adder based on ternary logic operators according to claim 1, wherein the following two ternary logic operators are combined at one operator bit of a ternary operator for implementation:
a first type: a ternary logic operator with a truth table having two columns and three rows or having two columns and three rows after transposition; and
a second type: a ternary logic operator with a truth table having one column and three rows or having one column and three rows after transposition.

12. The method for configuring an MSD parallel adder based on ternary logic operators according to claim 5, wherein if the addition of a 0 to the head of an intermediate result leads to that the highest bit is always 0 in subsequent conversion, the added 0 and the highest bit of the intermediate result are omitted or reserved.

13. A modified signed-bit (MSD) parallel adder based on ternary logic operators, configured by using the configuration method according to claim 1.
